(19) United States
(12) Patent Application Publication
(10) Pub. No.: US 2003/0088872 A1
(43) Pub. Date: May 8, 2003

(54) Advanced television system

(75) Inventors: Jonathan Maissel, Modi'in (IL); Yossef Tsuria, Jerusalem (IL); Reuven Wachtfogel, Jerusalem (IL); David Richardson, Ramat Hasharon (IL); Shlomo Kipnis, Jerusalem (IL); Yonatan Silver, Jerusalem (IL); Amir Eilat, Tel Aviv (IL); Moshe Kranc, Jerusalem (IL); Yishai Sered, Newton, MA (US); Gershon Bar-On, Kochav Hashachar (IL); Shabtai Atlow, Efrat (IL)

Correspondence Address: Welsh & Katz, Ltd., L. Friedman, 22nd Floor, 120 South Riverside Plaza, Chicago, IL, 60606, US

(73) Assignee: NDS Limited, Staines (GB)

(21) Appl. No.: 10/287,283

(22) Filed: Nov. 4, 2002

Related U.S. Application Data
(63) Continuation of application No. 09/515,118, filed on Feb. 24, 2000.
Application No. 09/515,118 is a continuation of application No. PCT/IL99/00344, filed on Jun. 23, 1999.
(63) Continuation-in-part of application No. 09/242,871, filed on Jun. 10, 1999.
Application No. 09/242,871 is a 371 of international application No. PCT/IL98/00307, filed on Jun. 30, 1998.

(30) Foreign Application Priority Data
Jun. 29, 1998 (IL) 125141
Jul. 3, 1997 (IL) 121230

(51) Int. Cl. G06F 3/00; H04N 5/445; G06F 13/00

(52) U.S. Cl. 725/46; 725/44; 725/47

(57) ABSTRACT

In a digital television recording method, programs are selected for recording based on analysis of program schedule information, user preferences, and the priority of previously recorded programs if there is insufficient memory.

The present application is a continuation of currently pending application Ser. No. 09/515,118, filed on Feb. 24, 2000 and entitled Advanced Television System, which is a continuation of PCT/IL99/00344, filed on Jun. 23, 1999 and entitled Advanced Television System. The present application is also a continuation in part of currently pending application Ser. No. 09/242,871, filed on Jun. 10, 1999 and entitled Intelligent Electronic Program Guide, which is a 371 application of PCT/IL98/00307, filed on Jun. 30, 1998 and entitled Intelligent Electronic Program Guide.

### FIELD OF THE INVENTION

The present invention relates to television systems in general, and in particular to electronic program guides for television systems and to digital television recording systems.

### BACKGROUND OF THE INVENTION

Electronic program guides are well-known in the art. Electronic program guides provide television program schedule information on the television screen. Typically, electronic program guides display a rectangular grid schedule on the television screen, and allow the viewer to navigate through the schedule and to perform a variety of functions for one or more programs appearing on the schedule. Typical prior art program guides and related technologies are described in the following patents and published applications:

U.S. Pat. No. 4,706,121 to Young and Reexamination Certificate B1 4,706,121 to Young;

U.S. Pat. No. 4,977,455 to Young;

U.S. Pat. No. 5,038,211 to Hallenbeck;

U.S. Pat. No. 5,151,789 to Young;

U.S. Pat. No. 5,323,240 to Amano et al.;

U.S. Pat. No. 5,353,121 to Young et al.;

U.S. Pat. No. 5,444,499 to Saitoh

U.S. Pat. No. 5,479,266 to Young et al.;

U.S. Pat. No. 5,479,268 to Young et al.;

U.S. Pat. No. 5,515,106 to Chaney et al.;

U.S. Pat. No. 5,524,195 to Clanton, ill et al.;

U.S. Pat. No. 5,550,576 to Klosterman;

U.S. Pat. No. 5,564,088 to Saitoh;

PCT published application WO 90/00847, assigned to Insight Telecast, Inc.;

PCT published application WO 91/07050, assigned to Insight Telecast, Inc.;

PCT published application 92/04801, assigned to Insight Telecast, Inc.; and

PCT published application WO 95/31069, assigned to Starsight Telecast, Inc.

Customization of program guide information based on information explicitly entered by a viewer is known in the art and is described, for example, in U.S. Pat. Nos. 5,479,266 and 5,479,268, mentioned above. Customization of program guide information based on the channel watched and time watched is described in the following U.S. Pat. Nos. 5,323,240; 5,444,499; and 5,564,088.

Broadcast methods of interest in the field of the present invention are described in DVB standard ETS 300-468.

The terms “agent” and “intelligent agent” are used interchangeably throughout the present specification and claims to refer to any machine-based assistant, including but not limited to a machine-based assistant implemented in software, with authority delegated from the user or users of the agent. Specifically, the terms “agent” and “intelligent agent”, as used herein, are not limited to agents used by a particular person and may include agents used by one person or a plurality of people, whether used in a domestic, commercial, or other context.

Intelligent agents are both in use and proposed for future use in computer systems, particularly computer systems connected to an internetwork such as the Internet. Publications describing the intelligent agent prior art and proposals for the future use of intelligent agents include the following:

1. Fah-Chun Cheong, Internet Agents: Spiders, Wanderers, Brokers, and 'Bots, published by New Riders Publishing, 1996, describes the state of the art in agents in general and in Internet agents in particular. Chapter 1, pages 3-35 and the bibliography thereto on pages 387-390 are particularly relevant to the agent prior art. On page 9, Cheong describes surrogate bots, which are agents to “relieve users of low-level administrative and clerical tasks, such as setting up meetings, sending out papers, locating information, tracking whereabouts of people, and so on.” Cheong gives the example of a visitor scheduling bot whose purpose is to assist in scheduling the visitors of the user of the bot.

On page 19, Cheong describes learning agents, a type of personal agent envisioned in the future for which “learning about the particular user's habits and goals, and tailoring to them accordingly” is the essential principle of operation. As an example of a learning agent, Cheong gives a calendar apprentice which helps a user organize the user's meeting schedule.

2. A World Wide Web Document found on the Internet at www.raleigh.ibm.com/iag/iaghome.html describes intelligent agents in general and IBM intelligent agents in particular. A copy of the document was obtained from the Internet on Sep. 24, 1996 at 2:14 PM.

3. A World Wide Web Document found on the Internet at www.raleigh.ibm.com/iag/iagptc2.html, entitled “The Role of Intelligent Agents in the Information Infrastructure”, describes various application areas that intelligent agents can enhance. In section 3.8, Adaptive User Interfaces, mention is made that “agent technology allows systems to monitor the user's actions, develop models of user abilities, and automatically help out when problems arise.” The document neither describes nor suggests the use of intelligent agents to customize an electronic program guide or any similar system component. A copy of the document was obtained from the Internet on Sep. 24, 1996 at 2:16 PM.

The above-mentioned prior art does not appear to describe or suggest the use of intelligent agents in any of the following contexts: in television systems; with a program guide in any context; or with an entity similar to a program guide in a computer system.

Today, television programs are recorded at home on low capacity magnetic tape storage devices using video cassette recorders (VCRs). Typically, conventional video cassettes store only three or four hours of good quality movies. Thus, in order to record many programming hours, a user must use several video cassettes.

A conventional VCR is typically a passive recorder since it does not determine what television material to record. Typically, the VCR must be programmed by the user in order to initiate recording, and programming options typically include only selection of a time to begin recording and a time to end recording.

When the user wants to see a portion of a recorded movie, the user must first determine in which cassette the movie is recorded since VCRs do not provide a recording content guide. Although the user may write on each cassette titles of movies recorded therein, most users do not keep track of the movies recorded on their video cassettes. This makes searching of movies in video cassettes difficult.

Even after the user determines which video cassette includes the required movie, the user must rewind the cassette or move forward to find the portion of the movie. Such operations are inconvenient and typically cause wear to the video cassette and several electromechanical parts of a VCR thereby resulting in a need for frequent repairs in video laboratories.

Some VCRs also provide an editing function which enables the user to edit a recorded movie. However, editing with a VCR is difficult and requires frequent rewinding or moving forward of video cassettes which, as mentioned above, causes wear to the video cassettes and several electromechanical parts of the VCR.

Thus, it is appreciated that a recording and retrieval system which enables easy access to selected portions of stored movies and simple editing of movies will be highly desired.

In a publication titled “Double Agent—Presentation and Filtering Agents for a Digital Television Recording system” by Meuleman et al. of Philips Research, Eindhoven, The Netherlands, dated Apr. 18-23, 1998, there is described a double agent which explores scenarios for automated selection of television programs and their presentation via anthropomorphic interfaces. The double agent operates on data recorded by an experimental digital VCR.

In a publication titled “SMASH—a concept for advanced use of storage at home” by Persoon of Philips Research, Eindhoven. The Netherlands, dated May 3, 1998, the concept of SMASH (Storage for Multimedia Applications and Systems) is described. The main goal of the project is to explore the future possibilities offered on the one hand by the massive amount of new digital services that enter the consumers home and on the other hand the impressive progress of storage technologies that are suitable for home use.

In a publication titled “Mediators—Guides through online TV services” by Kohar et al. of Philips Research, Eindhoven, The Netherlands, dated May 3, 1998, there are described anthropomorphic guides who aid users in selection and navigation to content in interactive television services.

The following US Patents are related to special effects in television: U.S. Pat. Nos. 4,080,626; 4,272,787; 4,768,095; 4,774,582; 4,777,531; 5,519,448; 5,621,473.

Israel Patent Application 121230, submitted Jul. 3, 1997 and corresponding published PCT Application WO 99/01984 both assigned to NDS Limited describe one system for using intelligent agents to customize an electronic program guide (EPG) based on user behavior, and is incorporated into this application.

Israel Patent Application 120174, submitted Feb. 8, 1997 and corresponding published UK Patent Application 2,322,030 both assigned to NDS Limited describes a method for producing and recording a digital data stream, and particularly for protecting recording of digital data streams including digital television data.

In a DAVIC (The Digital Audio-Visual Council) publication DAVIC/TC/APP/98/05/001 titled “Applications for Home Storage Based Systems”, dated May 1, 1998, there are described a number of applications which can be realized through the provision of home storage systems, made easy to use by appropriate use of content descriptions, markers, links and agent technologies.

The disclosures of all references mentioned above and throughout the present specification are hereby incorporated herein by reference.

### SUMMARY OF THE INVENTION

The present invention seeks to provide an improved electronic program guide for use in a television system. Throughout the present specification and claims, the term “television system” is used in a broad sense to include all types of television systems, including but not limited to any one or combination of the following: one-way systems; two-way systems; systems utilizing cable communication networks, satellite communication networks, telephone communication networks, other communication networks, or any combination thereof; and CATV systems. Particularly, both pay television systems and non-pay or free television systems are included in the term “television system”.

The present invention provides for customization of an electronic program guide by an intelligent agent. Typically, the intelligent agent monitors viewing behavior of one viewer or a plurality of viewers and creates a preference profile based on the monitored viewing behavior. The intelligent agent then preferably employs the preference profile to customize the electronic program guide based on the preference profile.

There is thus provided in accordance with a preferred embodiment of the present invention a television system including a television network, and transmitting apparatus for transmitting program schedule information to a multiplicity of subscriber units, at least one of the multiplicity of subscriber units including a receiving unit for receiving the program schedule information from the television network, a profile storage unit for storing at least one viewer preference profile of at least one television viewer, an intelligent agent for customizing the program schedule information based, at least in part, on the viewer preference profile, to produce a program guide including customized program schedule information, and display apparatus for displaying the program guide.

There is also provided in accordance with another preferred embodiment of the present invention a subscriber unit for use in a television system including a television network and transmitting apparatus for transmitting program schedule information, the subscriber unit including a receiving unit for receiving the program schedule information, a profile storage unit for storing at least one viewer preference profile of at least one television viewer, an intelligent agent for customizing the program schedule information based, at least in part, on the viewer preference profile, to produce a program guide including customized program schedule information, and display apparatus for displaying the program guide.

There is also provided in accordance with another preferred embodiment transmitting apparatus for transmitting program schedule information to a multiplicity of subscriber units, the transmitting apparatus including a headend, the headend including a profile storage unit for storing at least one viewer preference profile of at least one television viewer associated with one of the multiplicity of subscriber units, and an intelligent agent for customizing the program schedule information based, at least in part, on the viewer preference profile, to produce customized program schedule information, wherein the transmitting apparatus is operative to transmit the customized program schedule information to the one of the multiplicity of subscriber units, and at least one of the multiplicity of subscriber units includes a receiving unit for receiving the customized program schedule information from the television network, and display apparatus for displaying a program guide including the customized program schedule information.

There is also provided in accordance with another preferred embodiment of the present invention a headend for use in a television system including a television network and transmitting apparatus for transmitting customized program schedule information to at least one subscriber unit, the headend including a profile storage unit for storing at least one viewer preference profile of at least one television viewer associated with the at least one subscriber unit, and an intelligent agent for customizing the program schedule information based, at least in part, on the viewer preference profile, to produce customized program schedule information.

Further in accordance with a preferred embodiment of the present invention the transmitting apparatus includes network transmitting apparatus for transmitting over the television network.

Still further in accordance with a preferred embodiment of the present invention the transmitting apparatus includes recording apparatus for recording information on a removable medium, and means for sending the removable medium to a subscriber location including the subscriber unit, and the subscriber unit includes loading apparatus for loading the information from the removable medium into the subscriber unit.

Additionally in accordance with a preferred embodiment of the present invention the intelligent agent also includes profile determination apparatus for determining viewer preference profile information for at least one television viewer and for providing the viewer preference profile information to the profile storage unit for storage as a viewer preference profile, and the profile determination apparatus determines the viewer preference profile information by monitoring television viewing behavior of the at least one television viewer.

Moreover in accordance with a preferred embodiment of the present invention the television viewing behavior includes viewing at least a portion of at least one viewed television program.

Further in accordance with a preferred embodiment of the present invention the television viewing behavior includes the television viewer viewing only a portion of at least one viewed television program.

Still further in accordance with a preferred embodiment of the present invention the profile determination apparatus compares a length of the portion of the at least one viewed television program to a predetermined viewing threshold length to determine whether the length is greater than the threshold length, and the profile determination apparatus determines the viewer preference profile information based, at least in part, on whether the length is greater than the threshold length.

Additionally in accordance with a preferred embodiment of the present invention when the length is determined to be less than the threshold length, the profile determination apparatus determines the viewer preference profile information without regard to the viewing only a portion of the at least one television program.

Moreover in accordance with a preferred embodiment of the present invention when the portion is determined to be less than the threshold, the profile determination apparatus determines that the viewer is engaged in channel surfing behavior, and the profile determination apparatus determines the viewer preference profile information based, at least in part, on the channel surfing behavior.

Further in accordance with a preferred embodiment of the present invention the program schedule information includes a first plurality of criteria, at least one of the first plurality of criteria being associated with each of a second plurality of television programs, and the profile determination apparatus determines the viewer preference profile information based, at least in part, on at least one of the plurality of criteria associated with the at least one viewed television program.

Still further in accordance with a preferred embodiment of the present invention the profile determination apparatus determines the viewer preference profile information, at least in part, in accordance with input provided by the at least one television viewer.

Additionally in accordance with a preferred embodiment of the present invention the profile determination apparatus determines viewer preference profile information from a reaction of the at least one television viewer to previously displayed customized program schedule information.

Moreover in accordance with a preferred embodiment of the present invention each the viewer preference profile includes a viewer preference profile of exactly one viewer.

Further in accordance with a preferred embodiment of the present invention at least one the viewer preference profile includes a viewer preference profile of a plurality of viewers.

Still further in accordance with a preferred embodiment of the present invention the apparatus also includes viewer preference profile loading apparatus for providing a recorded viewer preference profile to the profile storage unit for storage.

Additionally in accordance with a preferred embodiment of the present invention the viewer preference profile loading apparatus receives the recorded viewer preference profile via the television network.

Moreover in accordance with a preferred embodiment of the present invention the viewer preference profile loading apparatus receives the viewer preference profile from profile storage apparatus located remotely thereto.

Further in accordance with a preferred embodiment of the present invention the customizing includes emphasizing at least a portion of the customized program schedule information based, at least in part, on the viewer preference profile.

Still further in accordance with a preferred embodiment of the present invention the customizing includes deemphasizing at least a portion of the customized program schedule information based, at least in part, on the viewer preference profile.

Additionally in accordance with a preferred embodiment of the present invention the customizing includes tailoring a custom channel based, at least in part, on the viewer preference profile.

Moreover in accordance with a preferred embodiment of the present invention the customizing includes automatically tuning to a program selected based, at least in part, on the viewer preference profile.

Further in accordance with a preferred embodiment of the present invention the customizing includes automatically recording, on recording apparatus, a program selected based, at least in part, on the viewer preference profile.

Still further in accordance with a preferred embodiment of the present invention the customizing includes ordering at least some of the customized program schedule information based, at least in part, on the viewer preference profile.

Additionally in accordance with a preferred embodiment of the present invention the display apparatus is operative to display an on-screen alert including at least part of the customized program schedule information.

Moreover in accordance with a preferred embodiment of the present invention the alert includes an unsolicited alert.

Further in accordance with a preferred embodiment of the present invention the unsolicited alert includes audience viewing information including an indication of a proportion of an audience currently viewing a program.

Still further in accordance with a preferred embodiment of the present invention the program includes a program currently being viewed by a viewer.

Additionally in accordance with a preferred embodiment of the present invention the program includes a program not currently being viewed by a viewer.

Further in accordance with a preferred embodiment of the present invention the display apparatus displays the on-screen alert a predetermined period of time before a scheduled starting time of a television program, the at least part of the customized program schedule information including information associated with the television program.

Still further in accordance with a preferred embodiment of the present invention the customizing includes displaying an indication of a proportion of an audience currently viewing a program.

Additionally in accordance with a preferred embodiment of the present invention the proportion of an audience includes a proportion of an audience viewing a program currently being viewed by a viewer.

Further in accordance with a preferred embodiment of the present invention the proportion of an audience includes a proportion of an audience viewing a program not currently being viewed by a viewer.

Still further in accordance with a preferred embodiment of the present invention the display apparatus includes an icon-based guide generator for producing an icon-based hierarchical program guide including the program schedule information, and the program guide includes the icon-based hierarchical program guide. The term “icon”, as used throughout the present specification and claims, is used in the sense commonly accepted in the art of computer programming, particularly computer interface design, to refer to a small picture, photograph, or other representation which is meant to pictorially recall to the user a function or functions associated therewith.

There is also provided in accordance with another preferred embodiment of the present invention a television system including a television network, and transmitting apparatus for transmitting program schedule information to a multiplicity of subscriber units, each subscriber unit including a receiving unit for receiving the program schedule information from the television network, an icon-based guide generator for producing a program guide including an icon-based hierarchical program guide including the program schedule information, and display apparatus for displaying the program guide.

There is also provided in accordance with another preferred embodiment of the present invention a subscriber unit for use in a television system including a television network and transmitting apparatus for transmitting program schedule information, the subscriber unit including a receiving unit for receiving the program schedule information from the television network, an icon-based guide generator for producing a program guide including an icon-based hierarchical program guide including the program schedule information, and display apparatus for displaying the program guide.

There is also provided in accordance with another preferred embodiment of the present invention a method for providing a program guide in a television system, the method including providing a television network, and transmitting program schedule information to a multiplicity of subscriber units, each subscriber unit performing the following steps receiving the program schedule information from the television network, storing at least one viewer preference profile of at least one television viewer, employing an intelligent agent to customize the program schedule information based, at least in part, on the viewer preference profile, to produce a program guide including customized program schedule information and displaying the program guide.

There is also provided in accordance with another preferred embodiment of the present invention a method for providing a program guide in a television system including a television network and transmitting apparatus for transmitting program schedule information, the method including receiving the program schedule information, storing at least one viewer preference profile of at least one television viewer, employing an intelligent agent to customize the program schedule information based, at least in part, on the viewer preference profile, to produce a program guide including customized program schedule information, and displaying the program guide.

There is also provided in accordance with another preferred embodiment of the present invention a method for providing a program guide in a television system, the method including providing a television network, and transmitting program schedule information to a multiplicity of subscriber units, wherein the step of transmitting includes storing at least one viewer preference profile of at least one television viewer associated with one of the multiplicity of subscriber units, employing an intelligent agent to customize the program schedule information based, at least in part, on the viewer preference profile, to produce customized program schedule information transmitting the customized program schedule information to the one of the multiplicity of subscriber units, receiving, at the one of the multiplicity of subscriber units, the customized program schedule information from the television network, and displaying a program guide including the customized program schedule information.

There is also provided in accordance with another preferred embodiment of the present invention a method for providing a program guide in a television system including a television network and transmitting apparatus for transmitting customized program schedule information, the method including storing at least one viewer preference profile of at least one television viewer associated with one of the multiplicity of subscriber units, and customizing the program schedule information based, at least in part, on the viewer preference profile, to produce customized program schedule information.

There is also provided in accordance with another preferred embodiment of the present invention a method for providing a program guide in a television system, the method including providing a television network, and transmitting program schedule information to a multiplicity of subscriber units, each subscriber unit performing the following steps receiving the program schedule information, producing a program guide including an icon-based hierarchical program guide including the program schedule information, and displaying the program guide.

There is also provided in accordance with another preferred embodiment of the present invention a method for providing a program guide in a television system including a television network and transmitting apparatus for transmitting program schedule information, the method including receiving the program schedule information, producing a program guide including an icon-based hierarchical program guide including the program schedule information, and displaying the program guide.

There is also provided in accordance with another preferred embodiment of the present invention a headend for use in a television system including a television network and transmitting apparatus for transmitting customized program schedule information to a multiplicity of subscriber units, the transmitting apparatus including the headend, the headend including a profile creation unit for creating at least one viewer preference profile of at least one television viewer associated with one of the multiplicity of subscriber units, based on viewer information associated with the one of the multiplicity of subscriber units, and a transmission unit for transmitting the at least one viewer preference profile to the one of the multiplicity of subscriber units.

There is also provided in accordance with another preferred embodiment of the present invention a method for providing a program guide in a television system including a television network and transmitting apparatus for transmitting customized program schedule information to a multiplicity of subscriber units, the method including creating at least one viewer preference profile of at least one television viewer associated with one of the multiplicity of subscriber units, based on viewer information associated with the one of the multiplicity of subscriber units, and transmitting the at least one viewer preference profile to the one of the multiplicity of subscriber units.

There is also provided in accordance with another preferred embodiment of the present invention a method for providing a viewer preference profile in a television system including a plurality of subscriber units, the method including recording. at a first subscriber unit, a viewer preference profile on a removable medium, loading, at a second subscriber unit, the viewer preference profile from the recording medium, and customizing a program guide, at the second subscriber unit, based, at least in part, on the viewer preference profile.

There is also provided in accordance with another preferred embodiment of the present invention a method for providing audience information to a viewer of a television system, the method including collecting viewing data from a multiplicity of viewers of a television system, computing audience information from the collected viewing data, and transmitting the computed audience information to a viewer of the television system.

Further in accordance with a preferred embodiment of the present invention the method also includes displaying the computed audience information to the viewer of the television system.

Still further in accordance with a preferred embodiment of the present invention the computed audience information comprises real-time computed audience information.

There is also provided in accordance with another preferred embodiment of the present invention a method for providing a program guide in a television system comprising a television network and transmitting apparatus for transmitting information to a multiplicity of subscriber units, the method including creating at least one viewer preference profile of at least one television viewer associated with one of the multiplicity of subscriber units, based on viewer information associated with the one of the multiplicity of subscriber units, creating a customized program guide based, at least in part, on the at least one viewer preference profile, and transmitting the customized program guide to the one of the multiplicity of subscriber units.

Further in accordance with a preferred embodiment of the present invention the transmitting step includes transmitting via at least one of the following:

conventional mail, electronic mail, provision of a World Wide Web site comprising said customized program guide, and wireless transmission to a portable electronic receiving device.

Still further in accordance with a preferred embodiment of the present invention the icon-based hierarchical program guide includes a plurality of icons, and at least one of the plurality of icons is associated with additional information, the additional information being provided to a user upon request.

Additionally in accordance with a preferred embodiment of the present invention the additional information includes at least one of the following: audio material; visual material; audio-visual material; multimedia material; a computer program; and at least one preview of at least one program.

Moreover in accordance with a preferred embodiment of the present invention the additional information includes a plurality of customized items of information, and at least one of the plurality of customized items of information is provided to the user based, at least in part, on at least one of the following: a user preference; a conditional access parameter; and a region in which said user is located.

The present invention seeks to provide digital television recording apparatus having a powerful yet simple user interface which enables manipulation of information recorded by the digital television recording apparatus.

In the present invention, television programs are recorded in a high capacity memory based on a continuously updated user profile. The television programs are also presented to a viewer based on the user profile. The television programs include various types of television material, such as programs, commercials, video clips, program guides, data, multimedia information, hypermedia links and teletex. The high capacity memory may include a high capacity hard disk and a high capacity external memory.

A user may either watch broadcast television or programs retrieved from the high capacity memory or link to other networks, such as the Internet. When viewing a program retrieved from the memory, the user has a variety of possibilities to manipulate the program, such as editing, marking and combining highlights in the program, tagging the program for retrieval under determinable conditions, changing parental control criteria and using special features, such as picture-in-picture (PIP). The user also has additional interactive features.

The user may switch from broadcast television to the stored program in a simple way. Additionally, one of the features provided by the digital television recording apparatus is program freezing in which the program is frozen when the user is required to stop watching television, and then automatically recorded in the memory from the moment of freeze. When the user is able to watch television again, the program is retrieved from the memory and the user may resume watching the program in a delayed mode from the moment of freeze.

Storage of television programs makes it possible to treat the programs as computer software programs and thus many advantages arise. Additionally, flexible programming tools may be adapted which are tailored to specific needs of television viewers. There is thus provided in accordance with a preferred embodiment of the present invention a digital television recording method including broadcasting a television program associated with a broadcaster set of parameters enabling access to a first set of predetermined portions of the program, operating an agent for determining whether to record the program and for associating with the program, upon recording of the program, an agent set of parameters enabling access to a second set of predetermined portions of the program, storing the program together with the broadcaster set of parameters and the agent set of parameters to generate an addressable program, retrieving at least a portion of the addressable program, displaying the at least a portion of the addressable program to a user; receiving from the user a user set of parameters enabling access to a third set of predetermined portions of the addressable program, editing the addressable program to include the user set of parameters enabling access to the third set of predetermined portions of the addressable program thereby generating an edited addressable program, and storing the edited addressable program.

Preferably, the agent set of parameters is operative to override at least a portion of the broadcaster set of parameters. The user set of parameters is preferably operative to override at least one of a portion of the broadcaster set of parameters, and a portion of the agent set of parameters.

Preferably, the broadcaster set of parameters includes a subset of parameters which cannot be overridden by any of the agent set of parameters and the user set of parameters.

Additionally, at least one of the broadcaster set of parameters, the agent set of parameters, and the user set of parameters may include a tag determining at least one of a program retrieval parameter and a content retrieval parameter.

Further additionally, the agent set of parameters includes a recording quality parameter determining a quality of recording of the program. The user set of parameters preferably includes a rating parameter determining a rating of the program as provided by the user.

The television program may include a commercial and the broadcaster set of parameters may include a commercial set of parameters. Preferably, the broadcaster set of parameters includes a parameter determining a request for additional information related to at least one of the commercial and the program. The broadcaster set of parameters also preferably includes a parameter determining expiration of the commercial after a predetermined number of people have seen the commercial or after the user has seen the commercial a predetermined number of times.

Additionally, the broadcaster set of parameters also includes a parameter disabling fast-forward/fast backward browsing through the program.

Alternatively or additionally, the television program includes two separate television programs displayed simultaneously in a picture-in-picture (PIP) mode on a television screen, and the user set of parameters includes a parameter determining a viewing selection for viewing only one of the two separate television programs on the full television screen.

Preferably, the broadcaster set of parameters includes at least one parameter determining at least one of the following information fields: a type of the program; supplementary information accompanying the program; an associated audio channel in a language which differs from a language used in an original audio channel associated with the program; program delete enabled/disabled; parental control associated with at least a portion of the program which requires parental control; an expiration time of the program; picture-in-picture availability; a program title; a time when the program is broadcast; a length of the program; a determination whether the program is encrypted; a compression format of the program; characteristics of the program; cancellation of material already transmitted in the program; selective routing of part of the material to selected users; context specific tagging; and a media item.

Additionally, the agent set of parameters includes at least one parameter determining at least one of the following information fields: a quality of recording of the program; a type of program whose recording is required; at least a title of a favorite program whose recording is required; a time and a date when recording of the program is required; and existence of a review attached to the program; context specific tagging; a media item; and a category of the program.

Further additionally, the user set of parameters includes at least one parameter determining at least one of the following information fields: a program rating provided by the user: a review of the program; a request for additional information relating to the program; a format of the program after editing operations; at least one highlight in the program; compression preferences for compressing the program prior to storage; image manipulation; and video wallpaper selection.

Preferably, the first set of predetermined portions of the program, the second set of predetermined portions of the program, and the third set of predetermined portions of the addressable program include identical portions of the program.

There is also provided, in accordance with a preferred embodiment of the present invention a digital recording method including determining whether to record a program, and recording the program in response to a recording determination at a recording quality determined by a recording quality parameter.

Further in accordance with a preferred embodiment of the present invention there is provided a digital recording method including determining whether to record a program, storing the program in response to a recording determination, and retrieving the program in accordance with a rating given to the program.

There is also provided in accordance with a preferred embodiment of the present invention a digital recording method including determining whether to record a program, storing the program in response to a recording determination, and retrieving the program in accordance with a browsing hierarchy.

Additionally in accordance with a preferred embodiment of the present invention there is provided a digital recording method including determining whether to record a program, recording the program in a circular buffer upon first activation of a freeze selector from a moment of the first activation of the freeze selector, conditionally accessing the program recorded in the circular buffer for retrieval of the program from the circular buffer upon second activation of the freeze selector, and playing the program retrieved from the circular buffer from the moment of the first activation of the freeze selector.

There is also provided in accordance with a preferred embodiment of the present invention apparatus for digital recording of a program including a receiver for receiving the program associated with a broadcaster set of parameters enabling access to a first set of predetermined portions of the program, an agent module operatively associated with the receiver and operative to determine whether to record the program and to associate with the program, upon recording of the program, an agent set of parameters enabling access to a second set of predetermined portions of the program, a memory operatively associated with the agent module and operative to store an addressable program, the addressable program including the program associated with the broadcaster set of parameters and the agent set of parameters, a display operatively associated with the agent module, the receiver and the memory and operative to display at least a portion of the addressable program to a user, an input/output (I/O) interface operatively associated with the agent module and operative to receive from the user a user set of parameters enabling access to a third set of predetermined portions of the addressable program, and a user programming manager operatively associated with the memory, the I/O interface, the agent module, the receiver and the display and operative to generate an edited addressable program by editing the addressable program to include the user set of parameters enabling access to the third set of predetermined portions of the program, and to store the edited addressable program in the memory.

In accordance with a preferred embodiment of the present invention there is also provided apparatus for digital recording of a television program including a processor for determining whether to record the television program, a memory associated with the processor and operative to store the television program in response to a recording determination received from the processor, and a recording quality selector associated with the processor and the memory and operative to select a recording quality parameter determining a quality of storage of the television program in the memory.

Additionally, the apparatus includes a freeze selector operatively associated with the processor, wherein upon a first activation of the freeze selector, the processor is operative to record the program in the memory from a moment of first activation of the freeze selector, and upon a second activation of the freeze selector, the processor is operative to play the program recorded in the memory from the moment of first activation.

Further additionally, the apparatus includes a rating activator associated with the processor and the memory and operative to input information determining a rating given to the program. The apparatus also preferably includes a NEXT key selector associated with the processor and the memory and operative to browse through television programs stored in the memory.

Preferably, the NEXT selector is operative to browse through television programs stored in the memory in accordance with an order determined by at least one of the following: the user; the agent; and the broadcaster. Additionally, the NEXT selector is operative to browse through television programs stored in the memory in accordance with a hierarchy. The hierarchy is preferably determined by at least one of the following: the user; the agent; and the broadcaster.

There is also provided in accordance with a preferred embodiment of the present invention apparatus for digital recording of a television program including a processor for determining whether to record the television program, a memory associated with the processor and operative to store the television program in response to a recording determination received from the processor, and a rating activator associated with the processor and the memory and operative to input information determining a rating given to the television program.

Additionally, the apparatus includes a freeze selector operatively associated with the processor, wherein upon a first activation of the freeze selector, the processor is operative to record the program in a circular buffer from a moment of first activation of the freeze selector, and upon a second activation of the freeze selector, the processor is operative to play the program recorded in the circular buffer from the moment of first activation.

Preferably, the apparatus also includes a NEXT key selector associated with the processor and the memory and operative to browse through television programs stored in the memory.

Further in accordance with a preferred embodiment of the present invention there is also provided apparatus for digital recording of a television program including a processor for determining whether to record the television program, a memory associated with the processor and operative to store the television program in response to a recording determination received from the processor, and a NEXT key selector associated with the processor and the memory and operative to browse through television programs stored in the memory.

There is also provided in accordance with a preferred embodiment of the present invention apparatus for digital recording of a program including a processor for determining whether to record the program, a circular buffer associated with the processor and operative to store the program in response to a recording determination received from the processor, a conditional access module for providing conditional access to the program stored in the circular buffer, and a freeze selector operatively associated with the processor, wherein upon a first activation of the freeze selector, the processor is operative to record the program in the circular buffer from a moment of first activation of the freeze selector, and upon a second activation of the freeze selector, the processor is operative to play the program recorded in the circular buffer from the moment of first activation in accordance with conditions determined by the conditional access module.

Preferably, the conditions determined by the conditional access module include disabling of fast-forward/fast-backward over selected portions of the program.

### BRIEF DESCRIPTION OF THE DRAWINGS

The present invention will be understood and appreciated more fully from the following detailed description, taken in conjunction with the drawings in which:

FIG. 1 is a simplified partly pictorial, partly block diagram illustration of a television system comprising a subscriber unit constructed and operative in accordance with a preferred embodiment of the present invention;

FIG. 2 is a simplified block diagram illustration of a portion of the apparatus of FIG. 1;

FIG. 3 is a simplified block diagram illustration of a preferred implementation of the intelligent agent of FIG. 2;

FIG. 4 is a simplified flowchart illustration of a preferred method of operation of the viewing information analysis apparatus of FIG. 3;

FIG. 5 is a simplified flowchart illustration of a preferred implementation of step 260 of FIG. 4;

FIG. 6 is a simplified flowchart illustration of a preferred method of determining whether a viewer is engaged in surfing behavior in step 280 of FIG. 5;

FIG. 7 is a simplified flowchart illustration of a preferred method of operation of the program schedule customization apparatus of FIG. 3;

FIG. 8A is a simplified partly pictorial, partly block diagram illustration of a television system comprising a subscriber unit constructed and operative in accordance with an alternative preferred embodiment of the present invention;

FIG. 8B is a simplified partly pictorial, partly block diagram illustration of a television system comprising a subscriber unit constructed and operative in accordance with another alternative preferred embodiment of the present invention; and

FIGS. 9A-9L are simplified pictorial representations of preferred embodiments of an electronic program guide, which may be displayed on the display of FIG. 1, FIG. 8A or FIG. 8B.

FIG. 10A is a simplified pictorial illustration of a system for playing programs stored and retrieved by digital television recording apparatus, the system being constructed and operative in accordance with a preferred embodiment of the present invention;

FIG. 10B is a simplified block diagram illustration of digital television recording apparatus in the system of FIG. 10A, the digital television recording apparatus being constructed and operative in accordance with a preferred embodiment of the present invention;

FIG. 11 is a simplified flow chart illustration of a preferred method of operation of the apparatus of FIGS. 10A and 10B; and

FIGS. 12A and 12B together constitute a simplified flow chart illustration of a preferred method of manipulation of television programs recorded in the apparatus of FIGS. 10A and 10B.

### DETAILED DESCRIPTION OF A PREFERRED EMBODIMENT

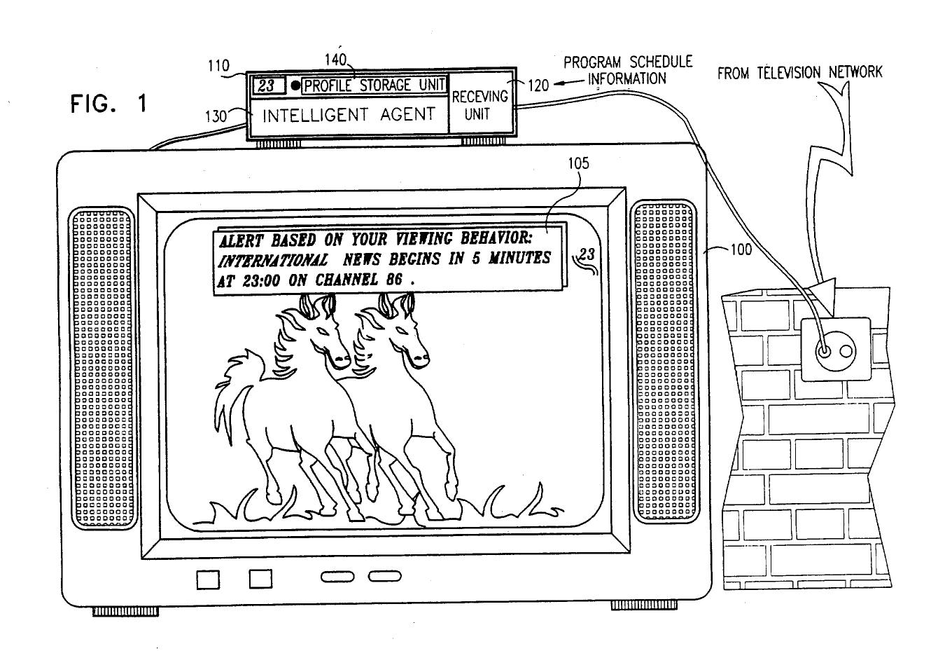

Reference is now made to FIG. 1 which is a simplified partly pictorial, partly block diagram illustration of a television system comprising a subscriber unit constructed and operative in accordance with a preferred embodiment of the present invention. The apparatus of FIG. 1 comprises display apparatus 100 for display of an electronic program guide, the display apparatus 100 typically comprising a television set as shown in FIG. 1. The television set may comprise any suitable commercially available television set.

It is appreciated that the display apparatus 100 may alternatively comprise any other suitable display apparatus such as, for example, a computer display, another suitable display, or suitable projection equipment, as is well known in the art. In a case where a display other than a television set is used, it is appreciated that a television set is typically provided separately. For the purpose of simplicity in description, a case where the display apparatus 100 comprises a television set is generally described throughout the present specification, but it is appreciated that another type of appropriate display apparatus may generally be used.

On the display apparatus 100 an on-screen alert 105 is shown. The onscreen alert 105 is described more fully below. The on-screen alert 105 is shown as an example of a component of an electronic program guide, as described below. It is appreciated that the electronic program guide may take a wide variety of forms and that, typically, the on-screen alert 105 is comprised in the electronic program guide and that the electronic program guide may comprise other components alternatively, or in addition to, the on-screen alert 105.

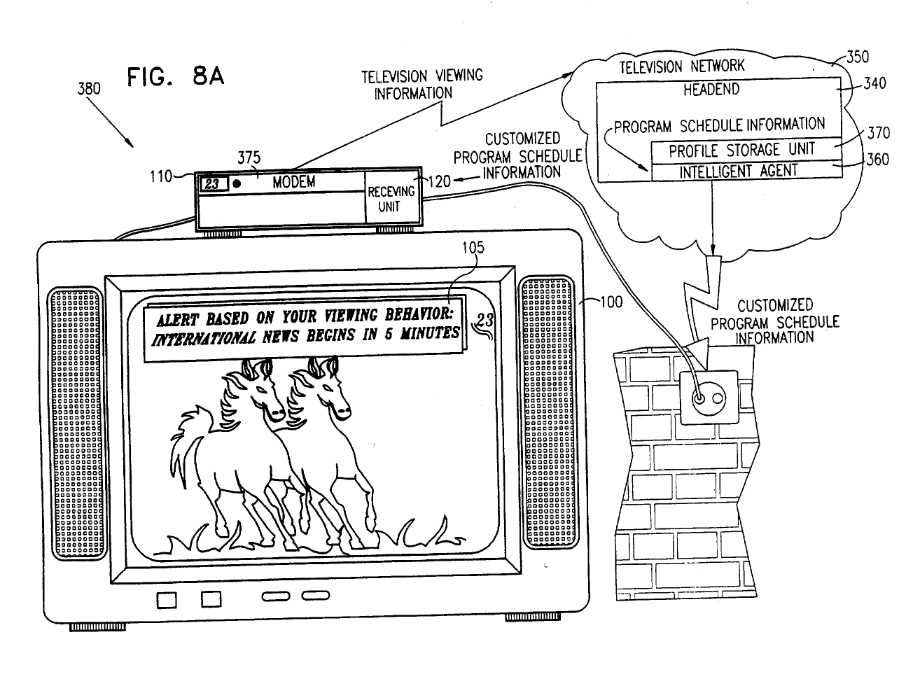

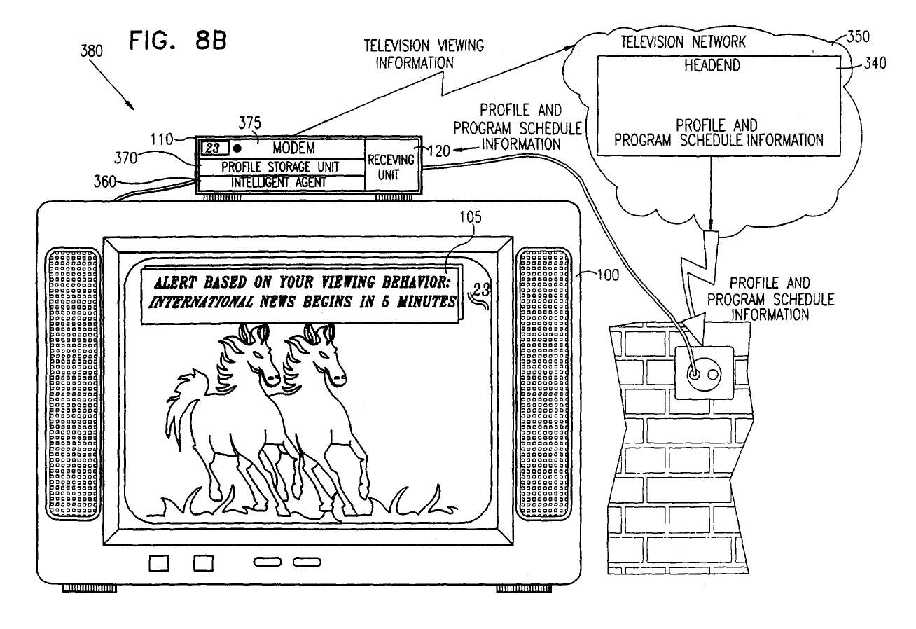

The apparatus of FIG. 1 also comprises an interface unit 110. The interface unit 110 is also known as a set top box (STB). The interface unit 110 is operative to provide a least a one-way interface, and optionally a two-way interface, between the display apparatus 100 and a television network, which may be either a pay television network or a non-pay or free television network. It is appreciated that, in certain preferred embodiments of the present invention such as, for example, the embodiments of FIGS. 8A and 8B, described below, a two-way interface is preferable. The interface unit 110 typically comprises a variety of conventional STB components (not shown), as is well known in the art, to receive, tune and, as necessary, decode television broadcasts received from the television network and to send display signals representing the received broadcasts to the display apparatus 100.

The interface unit 110 also typically comprises a receiving unit 120, an intelligent agent 130, and a profile storage unit 140, the receiving unit 120 and the profile storage unit 140 being operatively attached to the intelligent agent 130. The receiving unit 120, the intelligent agent 130, and the profile storage unit 140 are typically implemented in software in one or more suitable microprocessors suitably equipped with memory, but it is appreciated that a hardware implementation may also be used. The functions of the receiving unit 120, the intelligent agent 130, and the profile storage unit 140 are described in more detail below. The apparatus of FIG. 1 may also comprise a recording device such as a VCR (not shown), or any other appropriate conventional recording device including a DVCR (digital VCR) or DVD (digital video disc) recording device.

The operation of the apparatus of FIG. 1 is now briefly described. The interface unit 110 receives television broadcasts from the television network. A user of the apparatus of FIG. 1 chooses a channel to watch, using means well-known in the art such as, for example, a commercially-available remote control unit. The interface unit 110, responsive to the user's choice of channel, transmits display signals representing received broadcasts on the chosen channel to the display apparatus 100, as is well-known in the art.

As is well-known in the art, the television broadcasts typically also comprise television program schedule information. It is appreciated that program schedule information may alternatively or additionally be distributed by other non-broadcast methods such as, for example: by sending a removable medium to the user for insertion in an appropriate unit (not shown) for receiving the medium in the apparatus of FIG. 1; by publishing coded information, such as in a newspaper or magazine, and by providing equipment (not shown) for use with the apparatus of FIG. 1 to read the coded information into the apparatus of FIG. 1; or otherwise.

The terms “program schedule information” and “television program schedule information” are used interchangeably throughout the present specification and claims to refer to information describing a television program schedule. Program schedule information is typically intended to assist a television viewer in choosing a television program to watch, either at the current time or in the future. Program schedule information typically comprises one or more of the following:

channel number;

starting date;

starting time;

ending date;

ending time;

name of program;

description of program;

name of at least one actor in program;

name of director of program;

program provider;

price of program; and

classification criteria.

The classification criteria may typically comprise one or more of the following: indications of whether the program is a comedy, a drama, a documentary, a news program, etc.; an indication of whether the program contains material unsuited for younger viewers; the country of origin of the program; and any other appropriate classification criteria. A typical example of such criteria is described in DVB standard ETS 300-468, referred to above.

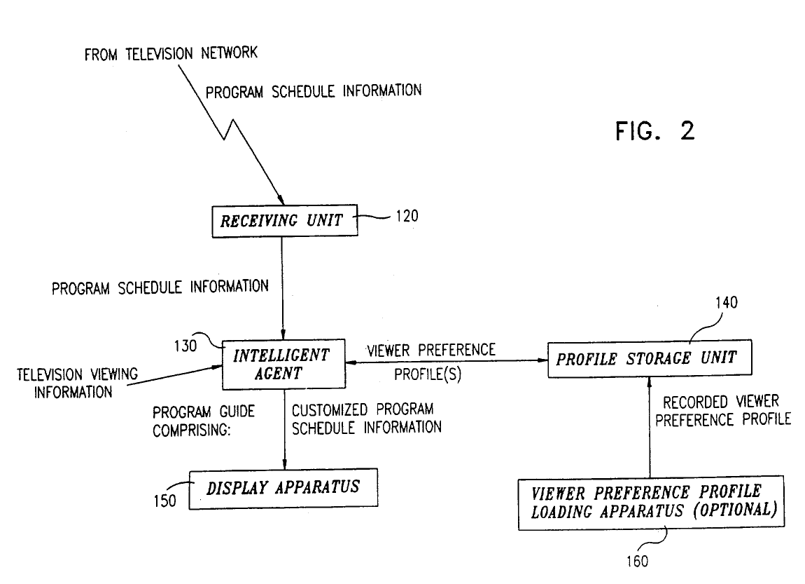

Reference is now additionally made to FIG. 2, which is a simplified block diagram illustration of a portion of the apparatus of FIG. 1. The apparatus of FIG. 2 comprises the receiving unit 120, the intelligent agent 130, the profile storage unit 140, and the display apparatus 150 of FIG. 2, and illustrates the connections therebetween as well as the inputs thereto and outputs therefrom. The apparatus of FIG. 2 also comprises an optional viewer preference profile loading apparatus 160 (not shown in FIG. 1), described below.

The receiving unit 120 is typically operative to receive the program schedule information from the television network and to pass the program schedule information to the intelligent agent 130. The receiving unit 120 may also be operative, as is well known in the art, to filter the program schedule information from other information broadcast via the television network, such as television programs, thus producing the information passed by the receiving unit 120 to the intelligent agent 130. The intelligent agent 130 also typically receives television viewing information representing current television viewing behavior of one or more individual viewers. The television viewing information, typically comprising an indication of the channel currently being watched and, optionally, viewer identification information, may be received from conventional components of the interface unit 110, as is well known in the art, or from another appropriate source.

It is appreciated that, in a case where the television viewing information comprises viewer identification information, the viewer identification information is typically obtained using methods well-known in the art for identifying viewers such as, for example, requiring one or more viewers to supply identifying information such as, for example, a personal identification number (PIN) before viewing television. Thus, the television viewing information may be associated with one or more viewers. It is also appreciated that, in a case where the television viewing information does not comprise viewer identification information the television viewing information is preferably taken to be general, that is, not to be associated with any particular viewer. For the sake of simplicity in description, a case where the television viewing information is associated with one or more viewers is generally described herein, but it is appreciated that the present invention also applies to the case where the television viewing information is not associated with any particular viewer.

The intelligent agent 130 is preferably operable to combine the television viewing information with the program schedule information and to extract therefrom characteristics, typically comprising components similar to those described above with respect to program schedule information, which characterize the television program currently being viewed by the viewer. Such components are also known herein as current program characteristics. The intelligent agent 130 is typically operative to store the current program characteristics in a viewer preference profile, typically in the profile storage unit 140, the viewer preference profile typically comprising information, obtained over a period of time, on the various current program characteristics of programs viewed by a viewer at various times. The period of time may be as short as a few minutes or as long as a year or more. The viewer preference profile also typically comprises information on the amount of time or proportion of duration of the program during which each program was viewed by the viewer.

Typically, the viewer preference profile may contain information on preference strength, that is, on how strongly a certain program or type of program is preferred by the viewer. Preference strength may reflect the number of times that the program was viewed in a given period of time, the percentage of all occurrences of the program that were viewed, or any other appropriate criterion. Typically, the viewer preference profile is accumulated over an unlimited amount of time. Alternatively, old information may be eliminated from the profile or the profile may be reset upon receipt of a signal from the television network.

Optionally, the apparatus of FIG. 1 may be operative to display a viewer preference profile on the display apparatus 100 or otherwise and to allow the viewer to edit or otherwise modify the viewer preference profile, typically using user interface methods well known in the art. In this case, the viewer is preferably enabled to add, delete, or modify any information in the viewer's viewer preference profile, it being appreciated that the apparatus of FIG. 1 is preferably operative to provide an appropriate questionnaire or other assisted data input method, as is well known in the art, in order to assist the viewer in adding, deleting, or modifying information. Particularly, the viewer is preferably enabled to provide information on programs or types of programs which the viewer prefers to view or prefers not to view. Furthermore, the viewer is preferably enabled to do one or more of the following:

turn off or on the collection of viewer preference profile information;

define different levels of highlighting, as described below;

turn the delivery of alerts on or off,

instruct the apparatus of FIG. 1 to include or not to include popular programs in the program guide;

instruct the apparatus of FIG. 1 to include or not to include programs having a certain rating, such as programs having a rating as unsuitable for children, in the program guide;

instruct the apparatus of FIG. 1 to include or not to include programs recommended by one or more critics in the program guide; and

perform any other appropriate action.

As described below, the viewer preference profile stored by the intelligent agent 130 and used as described below may comprise a simple data structure describing current program characteristics of programs viewed by a viewer and other information as stated above. It is appreciated, however, that the viewer preference profile may, in alternative embodiments of the present invention, take a wide variety of forms. For example, without limiting the generality of the foregoing, the viewer preference profile may comprise one or more rules abstracted from at least the current program characteristics of programs viewed by a viewer, the extraction and/or abstraction of such rules from the current program characteristics of programs viewed by a viewer and other information as stated above being possible using methods well-known in the art, particularly methods in use with rule-based expert systems.

Such rules, as is well known in the art, may comprise conditions and results to be carried out if the conditions are true. For example, such a rule might state that if the user preference level for news is greater than a given threshold and if a news program is scheduled within the next 30 minutes, a news alert should be presented on the screen. For the sake of simplicity in description, the case of a simple data structure will generally be described below, it being appreciated that other methods, such as, for example, a rule-based method, may also be used.

The intelligent agent 130 is also operative to customize the program schedule information received from the receiving unit 120 in accordance with one or more viewer preference profiles belonging to one or more viewers and to output a program guide comprising the customized program schedule information to the display apparatus 150 for display. It is appreciated that, in a case where more than one viewer preference profile is used, the plurality of viewer preference profiles may be combined by any appropriate method, including simply combining the profiles, giving complete preference to one profile over another profile, giving partial preference to one profile over another profile, or by any other appropriate combining method.

The term “customize” in its various forms, as used throughout the present specification and claims with reference to program schedule information to be comprised in a program guide, is used generally to refer to any kind of customization including, for example, one or more of the following:

changing the order in which programs appear in the program guide;

changing the order in which channels appear in the program guide;

removing certain programs from or adding certain programs to the program guide, the added programs typically comprising programs that were not previously displayed due to another customization;

highlighting or emphasizing certain programs in the program guide, possibly including multiple levels of highlighting or emphasis;

de-highlighting or deemphasizing certain programs in the program guide, possibly including multiple levels of de-highlighting or de-emphasis;

modifying a hierarchy, such as, for example, an icon-based hierarchy, of programs in the program guide;

modifying the appearance of an element of the program guide such as, for example, an icon, including modifying an icon to be non-objectionable for viewing by children;

displaying an alert comprising program schedule information;

customizing a channel to contain selected programs from the program guide, typically by creating a virtual channel comprising, for example, a list of times and channels on which preferred programs are broadcast at those times, to give a viewer the appearance that the viewer's preferred programs are all broadcast on the customized channel;

delivering an alert remind the viewer to record a program;

automatically recording a program; and

any other appropriate kind of customization.

It is appreciated that other factors in addition to a viewer preference profile may also be applied by the intelligent agent 130. Examples of such other factors and their typical use by the intelligent agent 130 include the following:

parental control information, which is well known in the art, may be used to eliminate certain programs from the program guide or to modify objectionable descriptions and/or icons so that they are suitable for viewing by children;

parental control or other information may be used to limit total viewing time or viewing during certain times of the day by removing programs falling outside the limitation from the program guide;

subscription information, typically including information on television services which have been subscribed to by a viewer, may be used to eliminate programs not subscribed for from the program guide;

rating information, typically including information on general viewer popularity of a program based on ratings as are well known in the art, may be used to modify the customization of the program guide, typically by including or promoting the importance of highly rated programs but possibly by excluding or reducing the importance of highly rated programs, and further possibly by modifying the viewer preference profile based on the rating information; and

language choice information, typically including information on a preferred language, may be used to display listings in a particular language or for program versions in a particular language, it being appreciated that viewer preference profile information on language viewing preferences may override language choice information.

The optional viewer preference profile loading apparatus 160, if present, may be used to load a recorded viewer preference profile of another viewer, including a viewer who has used another apparatus, similar to that of FIG. 1, at a different time and place. Such a recorded viewer preference profile may be provided on any appropriate recording medium, may be broadcast via the television network, or may be delivered from profile storage apparatus by any appropriate means. It is appreciated that a recorded viewer preference profile may typically be a profile of a well-known person, may be intended to provide customization of the program guide in a way similar to that which would be provided to the famous person, and may be provided for a fee or other consideration. The effect of using such a recorded viewer preference profile would be, approximately, to receive a customized program guide customized according to the preferences of the person who is the source of the recorded viewer preference profile.

Alternatively, a recorded viewer preference profile could be used as an anti-profile in the sense that customization could occur opposite to what would be the result of using the recorded preference profile; that is, a particular program that was preferred according to the recorded viewer preference profile could be, for example, deemphasized.

Optionally, the profile loading apparatus 160, if present, may also be operative to record a viewer preference profile on any appropriate recording medium such as, for example, a diskette or an appropriate smart card. The recorded viewer preference profile may then be provided to another viewer having apparatus similar to that of FIG. 1 for loading as described above.

It is appreciated that the implementation of the present invention described above, wherein a program guide is transmitted to a television, comprises one particular implementation of the present invention, and that the scope of the present invention is not limited by the above-described implementation. In particular, it is appreciated that, with minor variations as is well known in the art, a customized program guide could be delivered to a viewer by, for example, one or more of the following methods:

conventional mail;

electronic mail, including conventional electronic mail, electronic mail delivered to a television, text-based electronic mail, graphics-based electronic mail, HTML-based electronic mail, or any other suitable type of electronic mail;

a personalized World Wide Web site on the Internet; and

wireless delivery to a portable electronic device such as a suitable beeper, palmtop device, personal organizer, watch, radio receiver, or any other suitable portable electronic device.

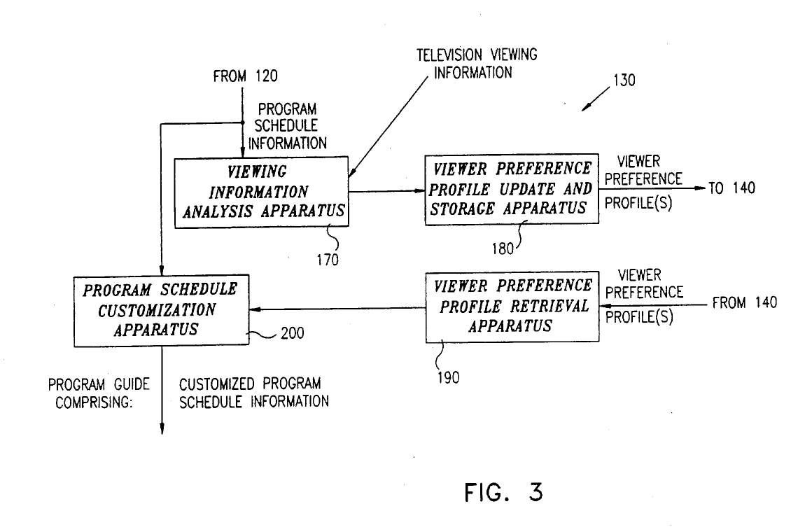

Reference is now made to FIG. 3, which is a simplified block diagram illustration of a preferred implementation of the intelligent agent 130 of FIG. 2. The apparatus of FIG. 3 preferably comprises viewing information analysis apparatus 170, which typically receives program schedule information from the receiving unit 120 of FIG. 2, as described above, as well as receiving television viewing information, as described above with reference to FIG. 2.

The apparatus of FIG. 3 also preferably comprises viewer preference profile update and storage apparatus 180. The viewing information and analysis apparatus 170 is preferably operative to provide current program information and information on the current viewer, typically comprised in the television viewing information, as described above with reference to FIG. 2, to the update and storage apparatus 180. The update and storage apparatus 180 is preferably operative to store the received information in an appropriate viewer preference profile in the profile storage unit 140 of FIG. 2.

The apparatus of FIG. 3 also preferably comprises viewer preference profile retrieval apparatus 190 and program schedule customization apparatus 200. The retrieval apparatus 190 typically retrieves the viewer preference profile of a viewer under control of the program schedule customization apparatus 200 and sends the viewer preference profile to the program schedule customization apparatus 200.

The program schedule customization apparatus 200 preferably receives the viewer preference profile, as well as the program schedule information from the receiving unit 120 of FIG. 2. The program schedule customization apparatus 200 is preferably operative to customize the program schedule information received from the receiving unit 120 in accordance with one or more viewer preference profiles belonging to one or more viewers and to output a program guide comprising the customized program schedule information.

The viewing information analysis apparatus 170, the viewer preference profile update and storage apparatus 180, the view preference profile retrieval apparatus 190, and the program schedule customization apparatus 200 are typically implemented in software in one or more suitable microprocessors suitably equipped with memory, but it is appreciated that a hardware implementation may also be used.

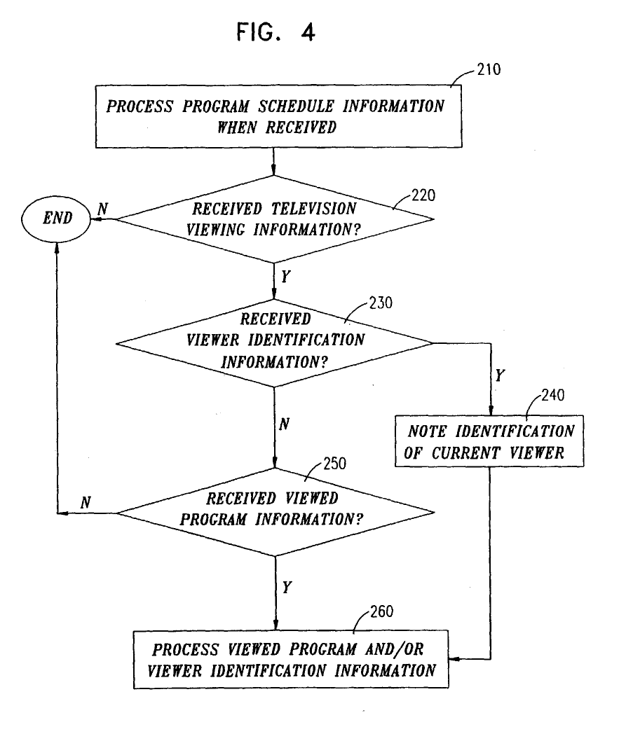

Reference is now made to FIG. 4, which is a simplified flowchart illustration of a preferred method of operation of the viewing information analysis apparatus of FIG. 3. The method of FIG. 4 preferably includes the following steps:

When program schedule information is received, the information is processed (step 210). Program schedule information is generally received when the program schedule information is sent over the television network. The program schedule information may be sent periodically, may be sent when there is a change in program schedule information, or may be sent at other times. Processing program schedule information preferably comprises updating a working copy of program schedule information kept in the intelligent agent 130 and used in other steps of the method of FIG. 4.

A check is made as to whether television viewing information has been received (step 220). Generally, television viewing information is received when there is a change in television viewing such as, for example: a new viewer begins viewing television according to viewer identification information; a television channel change occurs; or the television is turned on or turned off. Television viewing information may also comprise an indication that a viewer has responded to a customized alert positively, by tuning to the program named in the alert, or negatively, by not tuning to the program named in the alert. Preferably, such a positive response is taken to reinforce the preference which led to the alert. A negative response, on the other hand, is preferably taken to weaken or erase the preference which led to the alert.

If no television viewing information is received, the process of FIG. 4 preferably ends.

It is appreciated that, after step 220, further action need only be taken when some television viewing information is received, on the assumption that eventually some change in television viewing will occur and further action can be taken at that time. It is further appreciated that, to prevent a possibility of no television viewing information being received for a very long time such as, for example, for an entire day, step 220 may include a check for a very long time having passed since television information has been received and, in that case, the check of step 220 may preferably behave as if television viewing information, comprising viewed program information, has been received, in order to ensure that current television viewing information, even if unchanged, is eventually stored.

If television viewing information is found to have been received in step 220, a check is made as to whether the television viewing information comprises viewer identification information (step 230). If viewer identification information has been received, the identification of the current user is noted and preferably stored (step 240). Processing continues with step 260, described below.

If the check of step 230 does not show receipt of viewer identification information, a check is made as to whether viewed program information has been received (step 250). If not, the method of FIG. 4 preferably ends. If viewed program information was found to have been received in step 250 processing continues with step 260.

In step 260, viewed program information and/or viewer identification information are processed.

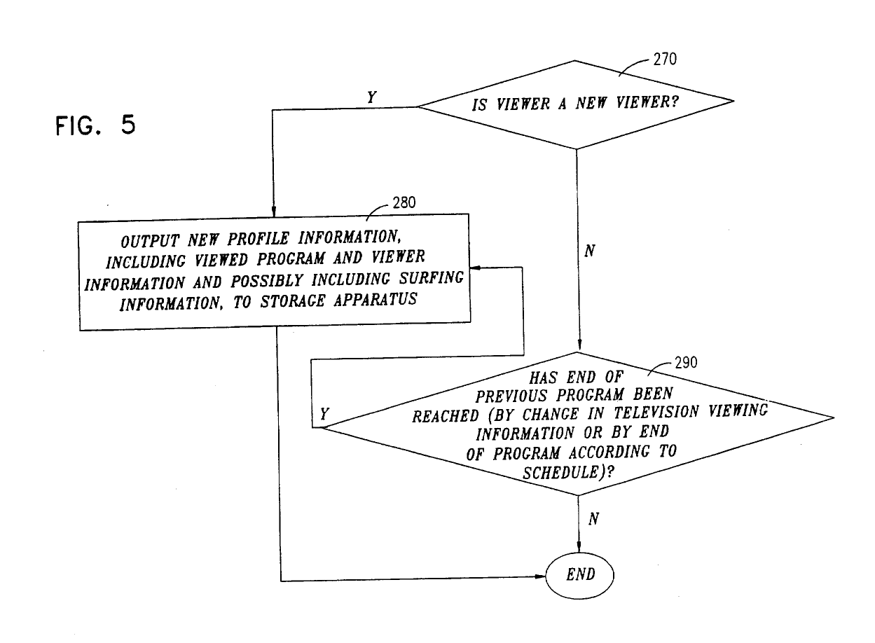

Reference is now made to FIG. 5, which is a simplified flowchart illustration of a preferred implementation of step 260 of FIG. 4. The method of FIG. 5 preferably comprises the following steps:

Checks are made as to whether the current viewer is a new viewer (step 270) and whether the end of the previous program has been reached, whether by a change in television viewing information or by reaching the end of a program according to the program schedule information (step 290). If either the check of step 270 or the check of step 290 is found to be true, new profile information is output. (step 280). The new profile information typically includes viewed program and viewer information.

In a case where the viewed program and viewer information indicate that the viewer has viewed a program for a short period of time, the new profile information may include surfing information, that is, an indication that the viewer prefers to surf, that is, to view programs only for a short period of time. The short period of time typically comprises a predetermined period of time, also termed herein a threshold.

The surfing information may include details such as, for example, how often the user surfs and for how long the user surfs. Alternatively, information about a program which the viewer has viewed for a short period of time may be ignored and may not be included in the new profile information. The term “short period of time”, as used in the context of the explanation of step 280, may include one or more of the following:

a short absolute period of time such as, for example, less time than a threshold measured in minutes, for example, 2 minutes or 5 minutes; and

a short relative period of time such as, for example, less than a certain percentage of the scheduled time of a program.

It is appreciated that the short period of time may vary in length according to time of day, day of week, day of year, price of a particular program, or according to any other appropriate criterion. It is further appreciated that, in a case where a viewer views different portions of a program, the times during which each portion was viewed are preferably added before comparison to the threshold.

When the profile information includes information indicating that the viewer prefers to surf, customized electronic program guide information based on the profile information may be tailored for a viewer who prefers to surf, by including randomized program selections as preferred program selections, for example.

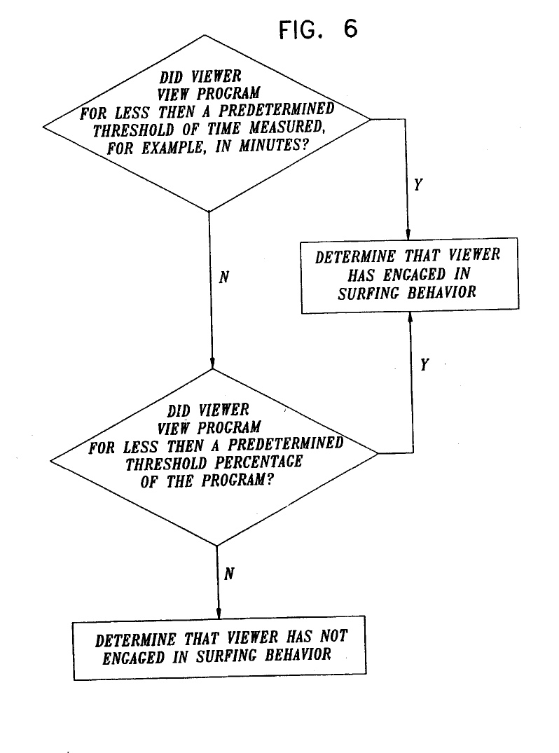

Reference is now made to FIG. 6, which is a simplified flowchart illustration of a preferred method of determining whether a viewer is engaged in surfing behavior in step 280 of FIG. 5. The method of FIG. 6 is self-explanatory.

It is appreciated that the method described above with reference to FIGS. 4-6 is one particular embodiment of a method of operation of the viewing information analysis apparatus of FIG. 3. The method of FIGS. 4-6 is provided by way of example only, and it is appreciated that other methods, including methods based on rule-based expert systems, as are well known in the art, may also be used.

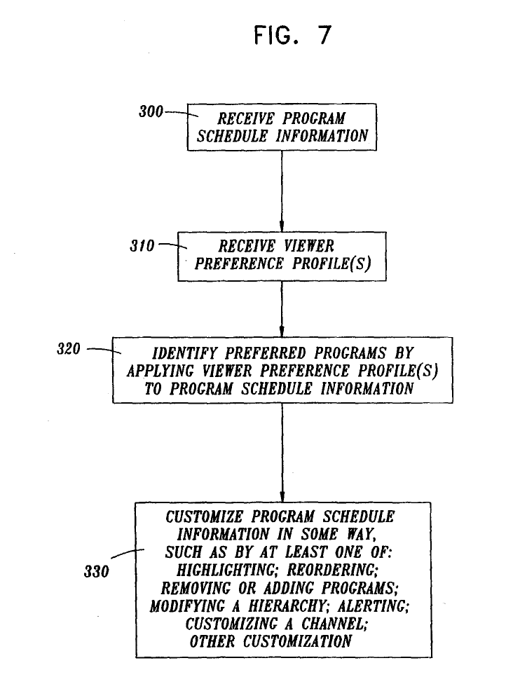

FIG. 7 is a simplified flowchart illustration of a preferred method of operation of the program schedule customization apparatus 200 of FIG. 3. The method of FIG. 7 preferably comprises the following steps:

The program schedule customization apparatus receives program schedule information (step 300) and at least one viewer preference profile (step 310).

The program schedule customization apparatus then preferably identifies preferred programs by applying the at least one viewer preference profile to the program schedule information (step 320). It is appreciated that similar results could be obtained by modifying step 320 to identify the programs which are not preferred, and then modifying the remainder of the method of FIG. 7 accordingly.

It is also appreciated that, depending on the form of the viewer preference profiles, as described above with reference to FIG. 2, the implementation details of step 320 will vary accordingly. For example, in a case where the viewer preference profile comprises a simple data structure describing current program characteristics of programs viewed by a viewer and other information, a preferred implementation of step 320 may comprise comparing the program schedule information to the information stored in the data structure and determining that programs in the program schedule whose characteristics resemble information stored in the data structure are preferred. For example, if information stored in the data structure indicates that news programs starting at 8:00 PM or later are preferred, such a news program will be identified as preferred in step 320. In a case where the viewer preference profile comprises rules, for example, the rules will typically be applied to the program schedule information, as is well known in the art, to determine which programs are preferred.

The program schedule is then customized (step 330). As described above with reference to FIG. 2, such customization may take a wide variety of forms.

Reference is now made to FIG. 8A, which is a simplified partly pictorial, partly block diagram illustration of a television system comprising a subscriber unit constructed and operative in accordance with an alternative preferred embodiment of the present invention. The system of FIG. 8A is similar to the system of FIG. 1, except as described below.

The system of FIG. 8A comprises a headend 340 comprised in or operatively associated with a television network 350. The headend 340 may be similar to conventional television system headends, as are well known in the art, except as described below.

The head end 340 comprises a head end intelligent agent 360 and a headend profile storage unit 370, which may be similar respectively to the intelligent agent 130 of FIG. 1 and the profile storage unit 140 of FIG. 1, respectively, except as follows.

Television viewing information may be transmitted to the headend 340 by a modem 375, which may be any conventional modem such as, for example, a telephone modem connected to a telephone network or a cable modem connected to a cable network. The modem 375 is typically comprised in or operatively associated with the interface unit 110. Alternatively, any appropriate means of communicating between the interface unit 110 and the headend 340 may be supplied, such as, for example, a VSAT satellite connection (not shown), as is well known in the art. The received television viewing information is processed in a manner similar to that described above with reference to the embodiment of FIG. 1.

The headend profile storage unit 370 is typically operative to store viewer preference profiles for a wide variety of viewers located at a multiplicity of sites. The intelligent agent 360 is operative to receive one or more viewer preference profiles associated with a particular site, such as a site 380, and to prepare customized program schedule information intended for the particular site. In the embodiment of FIG. 8A the headend 340 is operative to deliver the customized program schedule information to the particular site using methods well known in the art.

It is appreciated that, generally, the embodiment of FIG. 8A differs from the embodiment of FIG. 1 in that processing and storage largely occur in the head end 340. The embodiment of FIG. 8A may be preferable in a case where processing power may be provided more economically in a headend or in other cases. Furthermore, it is appreciated that, in the embodiment of FIG. 8A, certain types of customization may occur at the headend based on user preference profiles. For example, if users tend to prefer to watch a certain type of movie at a certain hour or hours of the night, that type of movie may be broadcast, either conventionally or in a near-video-on-demand system, at that hour or hours of the night. It is appreciated that other types of customization, as referred to above with respect to FIG. 2, may also occur at the headend.

It is further appreciated that other types of data processing and analysis may occur at the head end 340, the other types of data processing and analysis typically being directed to provide additional programming information to viewers. Without limiting the generality of the foregoing, it is appreciated that, at the headend 340, real-time information on a proportion or percentage of the audience viewing a particular program may be computed. The term “audience”, as used throughout the present specification and claims, refers either to the sum total audience viewing all programs at a particular time, or to the total audience of viewers who are capable of receiving programs at a particular time. The real-time information may then be transmitted to subscribers and display information derived from the transmitted information may then be displayed on the display apparatus 100.

Typically, the display information may comprise an alert to a user of the display apparatus 100, similar to the alert 105, informing the user that a program on another channel is currently being viewed by a large proportion of the audience and optionally suggesting that the user tune to that program or offering the user a shortcut, as is well known in the art of television broadcasting, to quickly tune to that program. Alternatively, any appropriate method of displaying the display information, such as displaying a bar graph or other graph indicating the proportion of the audience currently viewing the program presently being viewed by the user or the proportion currently viewing some other program, may be used. It is appreciated that the display information may be displayed, for example, at one or more of the following times: throughout viewing of a program; for a short time when a user tunes to a program; and on demand by a user, typically expressed by pressing a designated button on a remote control unit (not shown) as is well known in the art.

Reference is now made to FIG. 8B which is a simplified partly pictorial, partly block diagram illustration of a television system comprising a subscriber unit constructed and operative in accordance with another alternative preferred embodiment of the present invention. The system of FIG. 8B is similar to the system of FIG. 8A, except that in FIG. 8B the profile storage unit 370 and the intelligent agent 360 are comprised in the interface unit 110.

The operation of the system of FIG. 8B is similar to the operation of the system of FIG. 8A, except that in the operation of the system of FIG. 8B the headend 340 is operative to deliver a user preference profile which is typically different for each site, along with program schedule information which is typically the same for each site. It is appreciated that the user preference profile may be delivered only relatively infrequently such as, for example, once per day or once per month or even less often, in which case the embodiment of FIG. 8B might be preferred because of a relatively small bandwidth required to deliver the user preference profile and the program schedule information.

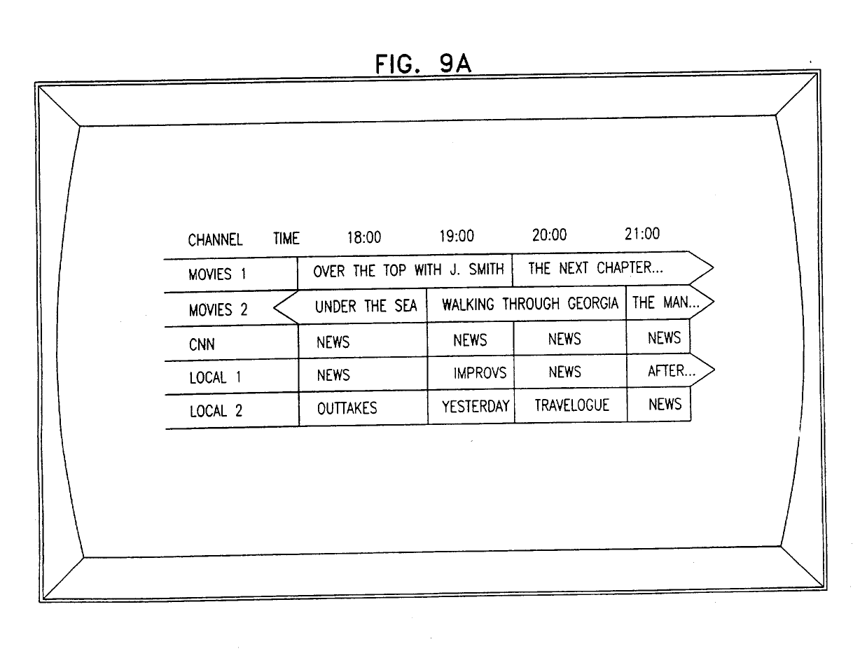

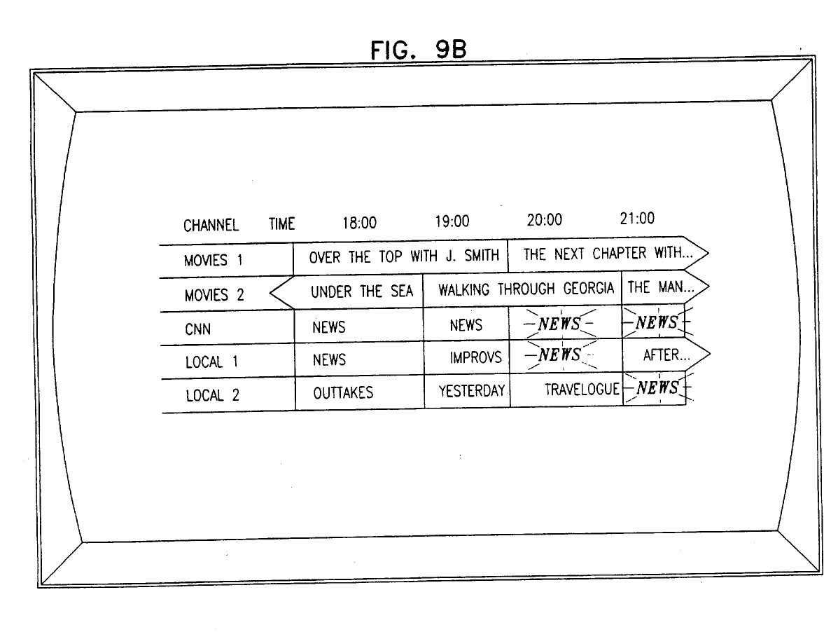

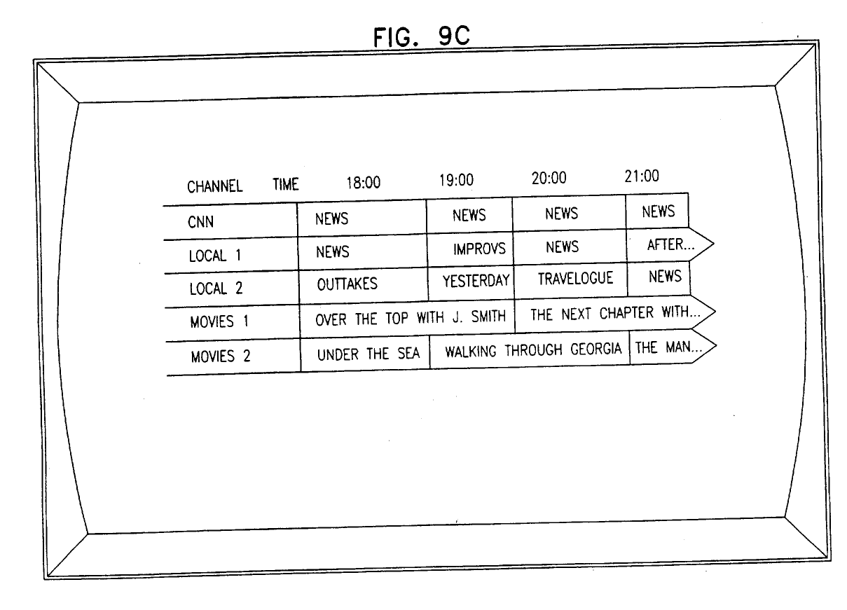

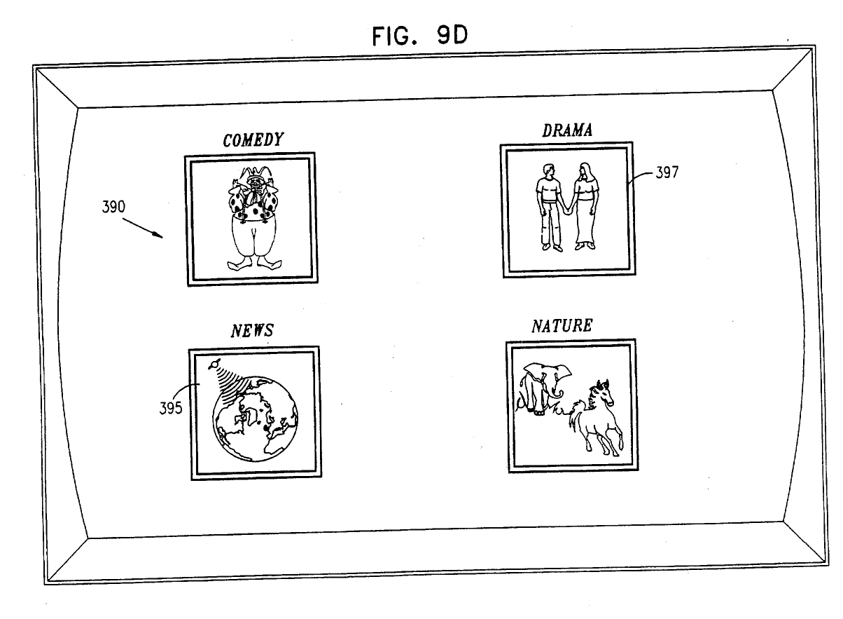

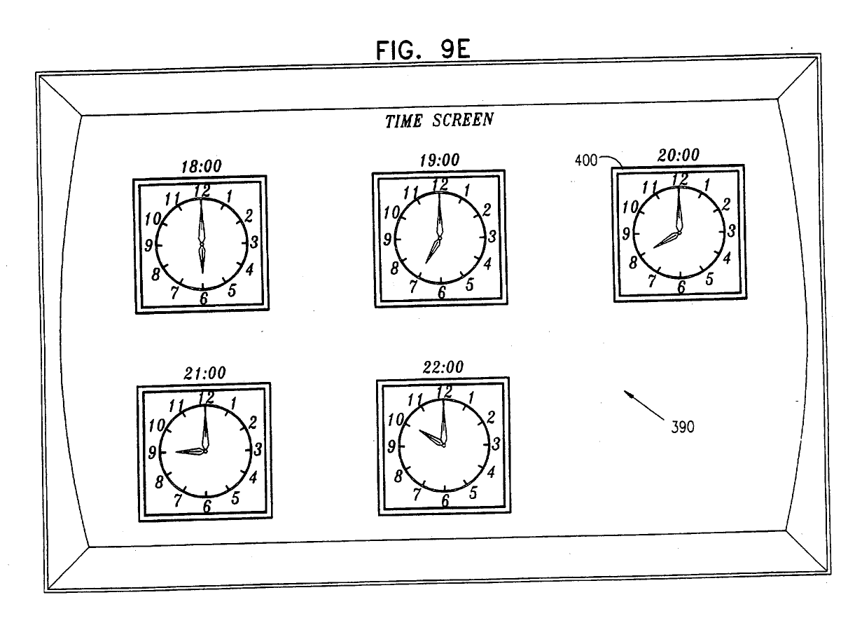

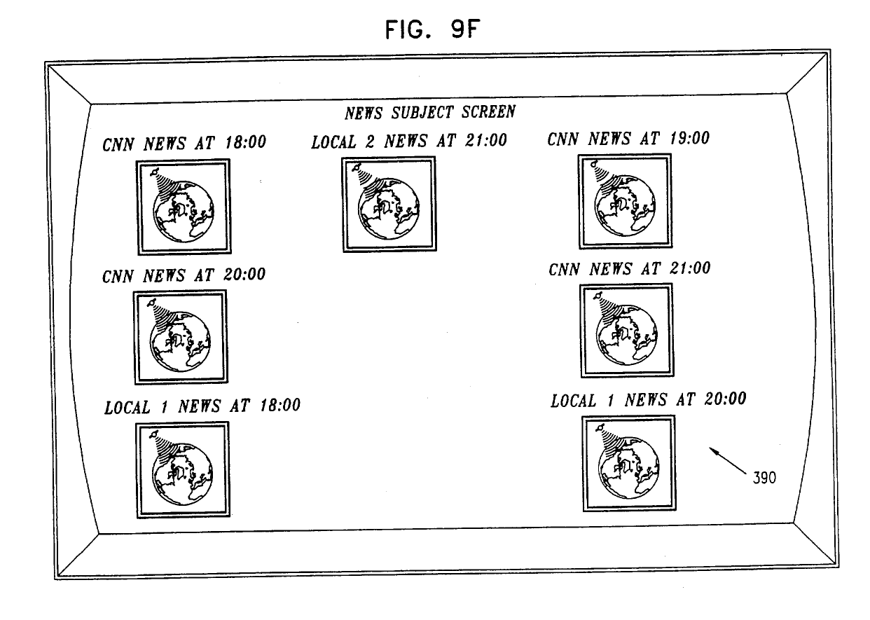

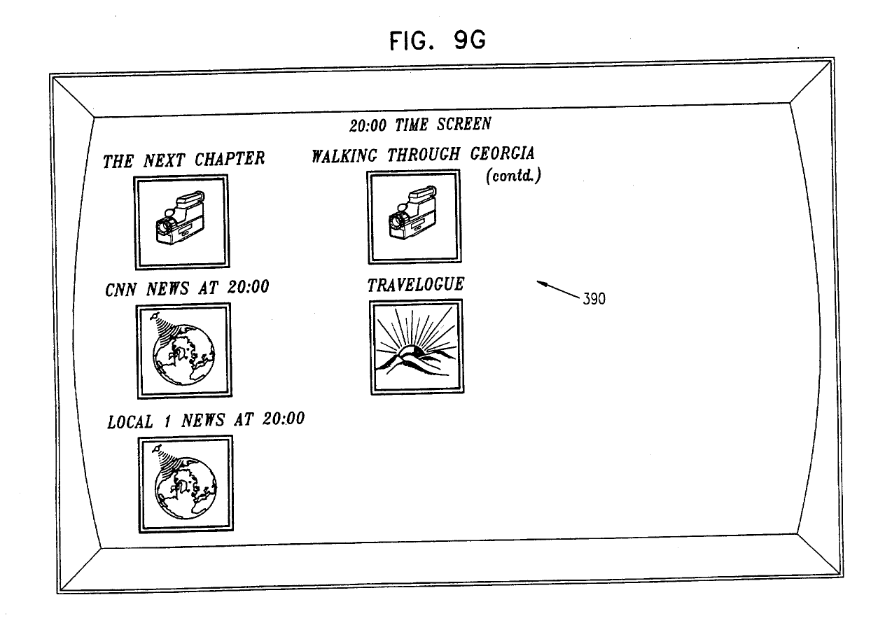

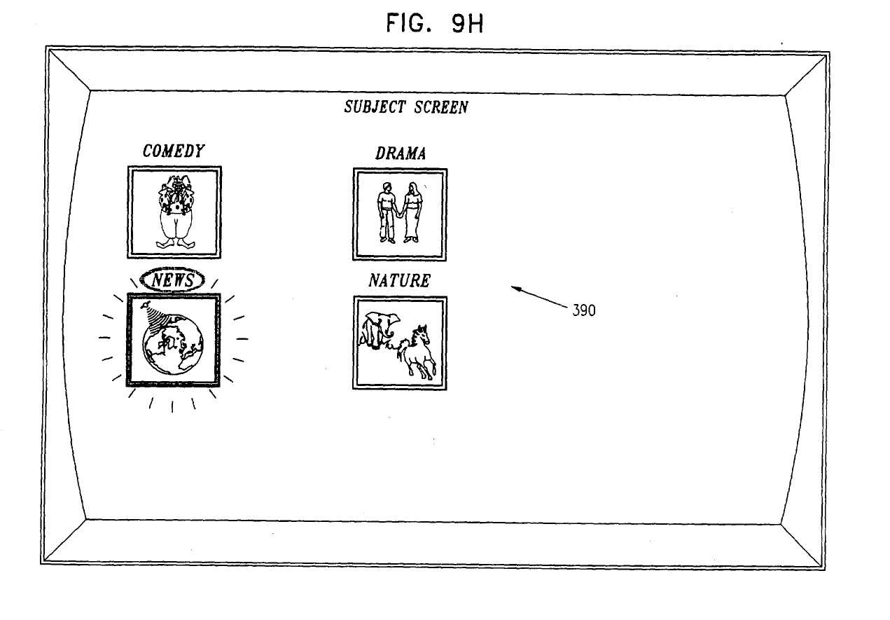

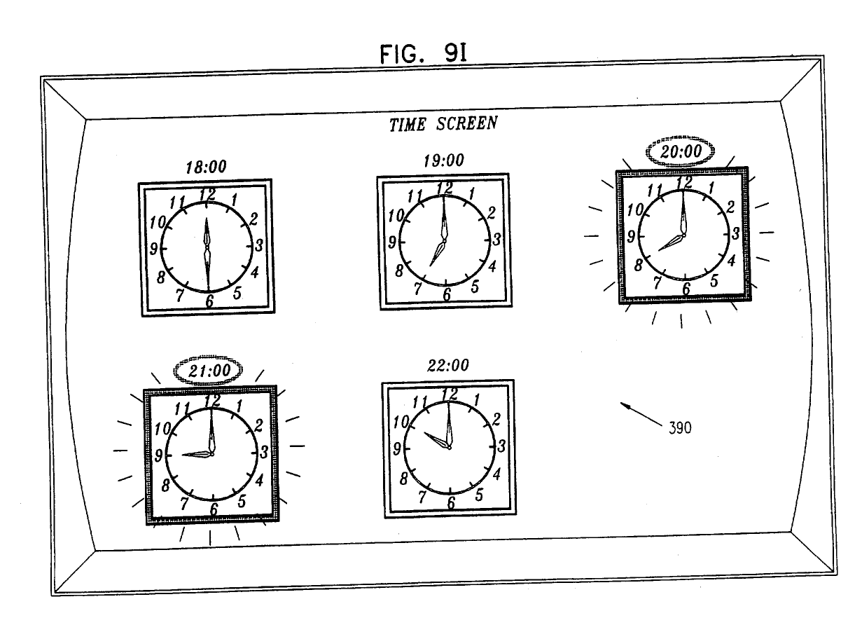

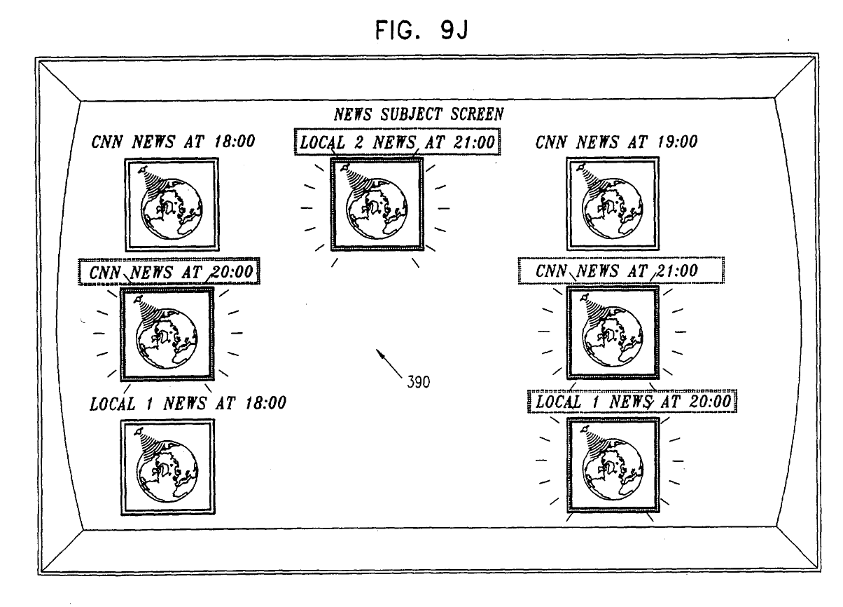

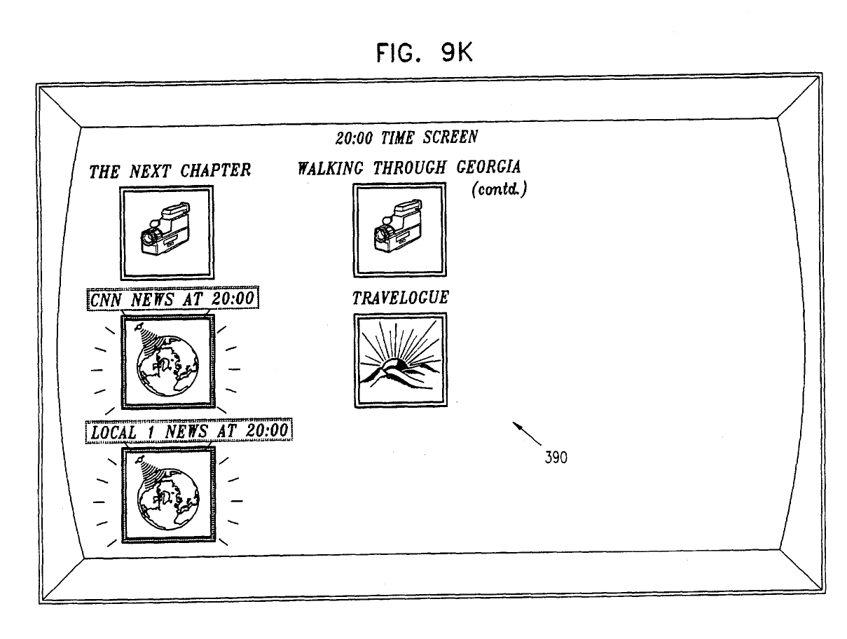

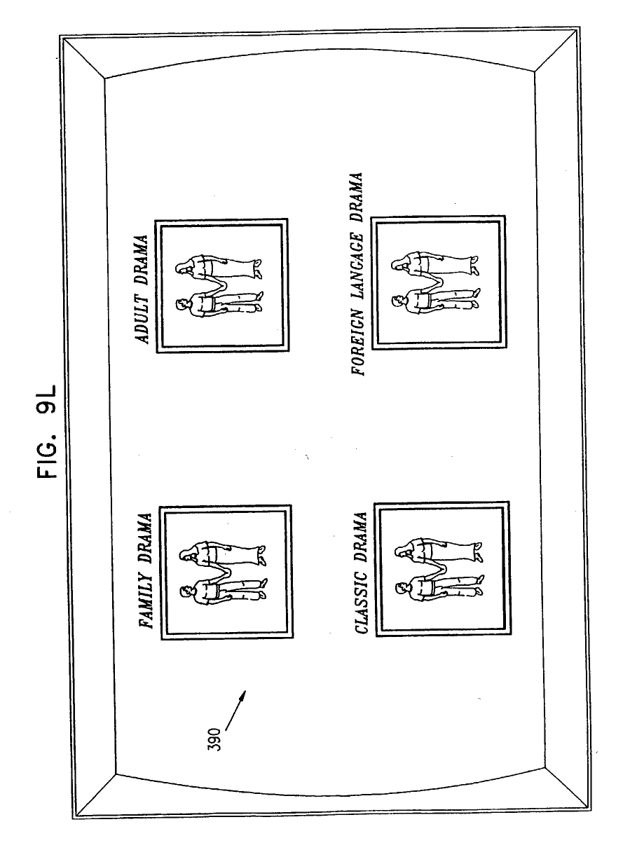

Reference is now made to FIGS. 9A-9L, which are simplified pictorial representations of preferred embodiments of an electronic program guide, which may be displayed on the display of FIG. 1, of FIG. 8A, or of FIG. 8B. Each of FIGS. 9A-9L comprises, as described below, one screen display which may be part of an electronic program guide. For the purposes of the discussion below of FIGS. 9A-9L it is assumed that the viewer preference profile governing electronic program guide customization shows a preference for news programs beginning at 8:00 PM or later. It is appreciated that the same principles shown and described with reference to FIGS. 9A-9L apply to a wide variety of viewer preference profiles, including viewer preference profiles which are much more complicated than the given example.

The screen display of FIG. 9A shows a typical simplified example of a non-customized grid-type screen display, with time being shown in a first dimension and television channels being shown in a second dimension, the resulting grid being filled in with names of television programs scheduled for the indicated time and the indicated channel. As is well known in the art, various navigation techniques exist for a user of a program guide such as that of FIG. 9A to choose a given program, obtain more information about the program, book the program for future viewing, etc.

The screen display of FIG. 9B shows a typical simplified example of the screen display of FIG. 9A after customization. In FIG. 9B, news programs beginning at 8:00 PM or later are emphasized. It is appreciated that, as described above, such emphasis may be by highlighting, by a change in color, or by other means. It is appreciated that such highlighting, change in color, or other means may comprise a multi-valued scale, such that, for example, different kinds of highlighting or different colors may represent different levels of emphasis.

The screen display of FIG. 9C shows an alternative typical simplified example of the screen display of FIG. 9A after customization. In FIG. 9C, channels having news programs beginning at 8:00 PM or later have been reordered to appear at the beginning of the list of channels. It is appreciated that, in addition to reordering, emphasis as described above with reference to FIG. 9B may also be used.

The screen display of FIG. 9D shows a typical simplified example of an icon-based non-customized electronic program guide. In FIG. 9D, the icons 390 on the screen display represent program subject matter such as, for example, comedy programs or, as indicated by a news icon 395, news programs and, as indicated by a drama icon 397, drama programs. The viewer may preferably select, using methods well known in the art such as by moving a cursor and selecting with a mouse (not shown) or other input device well-known in the art, any of the icons 390 of FIG. 9D in order to obtain more detailed information on programs falling under the selected subject matter. In FIG. 9E, the icons 390, such as an 8:00 PM icon 400, represent particular times at which programs start, and icons may preferably be selected as described above with reference to FIG. 9D.

It is appreciated that a wide variety of different methods of icon organization may be provided, of which those of FIGS. 9D and 9E are only examples. It is further appreciated that, using methods well known in the art, a viewer may choose a method of icon organization or create a custom method of icon organization. For example, icons may be used to represent listings for a particular series of programs or set of related series of programs, including a user-defined series of programs, which method of organization may be preferable in a case where users desire to see programs of a particular series.

The screen display of FIG. 9F shows a typical simplified example of a screen display after a viewer selects the news icon 395 of FIG. 9D. The screen display of FIG. 9G shows a typical simplified example of a screen display after a viewer selects the 8:00 PM icon 400 of FIG. 9E.

FIGS. 9H-9K show typical simplified examples of the screen displays 9D-9G, respectively, customized to emphasize news programs beginning at 8:00 PM or later. It is appreciated that such icon-based customization may take a wide variety of forms, including: different forms of emphasis; re-ordering the hierarchical relationship between different icons and screens of icons; creating new icons; removing icons; and other forms of icon-based customization. It will be appreciated that such methods of changing the appearance and the hierarchical relationships of icons are well known in the art of computers and that those methods or any other appropriate methods could be applied to the present invention.

It is appreciated that the screen displays of FIGS. 9D-9G may be hierarchical and, generally, may be hierarchical to any desired depth, with a plurality of choices being generally possible at each level, and with many possible selections and/or arrangements of icons displayed at each level. To illustrate another possible level of hierarchy, FIG. 9L shows a possible hierarchical drama screen that may be displayed after user selection of the drama icon 397 of FIG. 9D.

It is further appreciated that, in FIGS. 9A-9K, any icon may be associated with additional material, which additional material may be presented to the user upon request, such as by pressing a particular button or by any other appropriate method. The additional material preferably comprises any material associated with the subject matter of the icon, particularly material which might help clarify to the user the meaning of the icon and of its underlying content. For example, and without limiting the generality of the foregoing, the additional material may comprise one or more of the following: audio material; visual material; audio-visual material; multimedia material; a computer program or other related material comprising computer instructions or software; and one or more previews of one or more associated programs. Any appropriate method known in the art, such as force tuning to a special program or downloading additional material on demand, may be used to present the additional material to the user.

It is appreciated that the additional material may be particularly useful in systems where one of a plurality of languages and/or dialects is preferred by each user and in cases where very complex character sets, such as, for example, Chinese characters and/or characters in certain other Oriental languages, are used to write a language. In such cases, audio material comprised in the additional material may provide an audio description in cases where providing a written description is technically difficult because of bandwidth limitations in presenting complex character sets or other limitations. In a case where one of a plurality of languages and/or dialects is preferred by each user, the language and/or dialect used in the additional material may be determined by one of the following: user preference information; conditional access parameters such as, for example, geographic information, as is well known in the art; or by any other appropriate method.

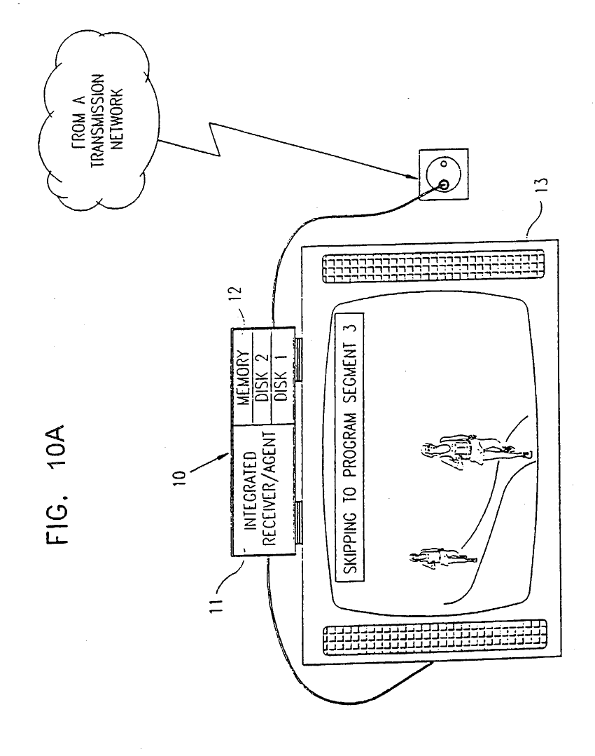

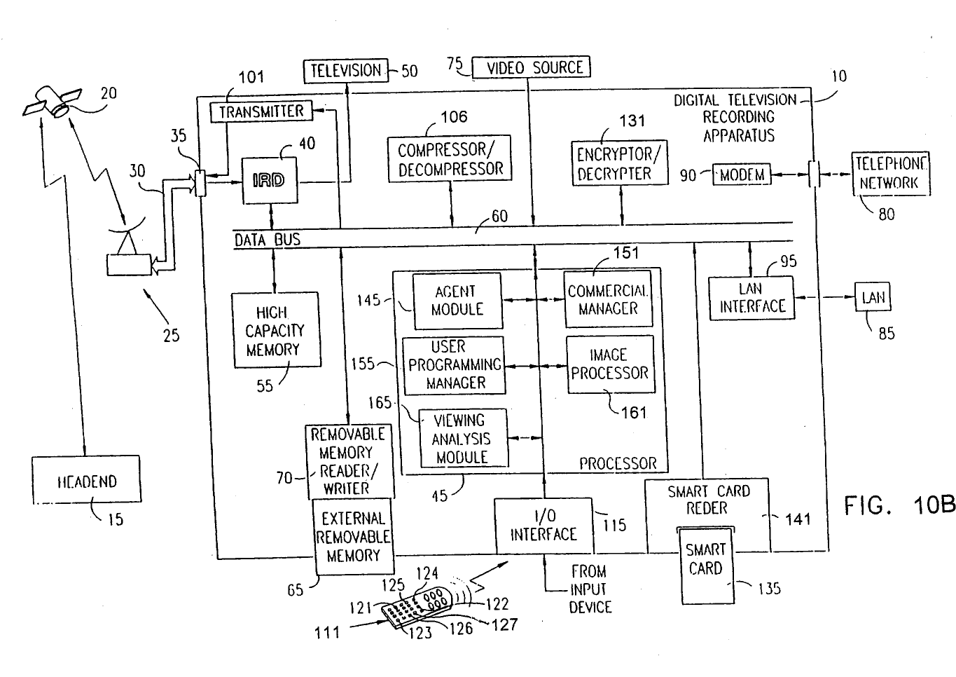

Reference is now made to FIG. 10A which is a simplified pictorial illustration of a system for playing programs stored and retrieved by digital television recording apparatus 10, the system being constructed and operative in accordance with a preferred embodiment of the present invention.

Preferably, the apparatus 10 includes an integrated receiver and agent (IRA) portion 11 and a memory portion 12. The apparatus 10 preferably, receives programs from a transmission network and stores the programs in the memory portion 12.

The terms “program” and “television program” are interchangeably used throughout the specification and claims to include various types of transmitted material, such as television programs, commercials, video clips, program guides and electronic program guides (EPGs), data, multimedia information, hypermedia links, computer programs, computer data and applications which may be downloaded, program applets and teletex.

Preferably, the programs may be stored in the memory portion 12 and/or retrieved from the memory portion 12 in accordance with instructions provided by an intelligent agent, generally referred to as an agent, which is resident in the IRA portion 11. The instructions provided by the agent are preferably determined by the agent in accordance with viewing habits of a user learned by the agent.

Preferably, programs retrieved from the memory portion 12 may be displayed on a display 13 which may include any appropriate type of a conventional display. Preferably, the display 13 is operatively associated with the apparatus 10. When a program retrieved from the memory portion 12 is displayed on the display 13, an alert 14 indicating that the program is a stored program may be displayed on the display 13.

Reference is now made to FIG. 10B which is a simplified block diagram illustration of the digital television recording apparatus 10 in the system of FIG. 10A, the apparatus 10 being constructed and operative in accordance with a preferred embodiment of the present invention.

Preferably, the apparatus 10 receives programs from a headend 15 via a satellite 20 or by broadcast. Alternatively, the apparatus 10 may receive programs from a cable headend (not shown).

The television programs are preferably received at an antenna 25 and provided, via a coaxial cable 30 and a connector 35, or any other appropriate conventional means, to the apparatus 10. At the apparatus 10, the television programs are preferably received and decoded in an integrated receiver and decoder (IRD) 40 which preferably includes a conventional IRD.

Preferably, the television programs received at the IRD 40 are tuned to and decoded under control of a processor 45. Decoded television programs are preferably provided, under control of the processor 45, either directly to a television 50 or to a high capacity memory 55 preferably via a data bus 60. It is appreciated that the television 50 may be a preferred type of the display 13 of FIG. 10A.

The high capacity memory 55 may preferably include a conventional high capacity hard disk as used in conventional personal computers or a plurality of high capacity hard disks. It is appreciated that today a conventional computer typically includes a hard disk having a capacity of 2-4 Gigabyte, and hard disks with capacities of 10 Gigabyte are considered today as state-of-the-art. Prototypes of hard disks having higher capacities, such as 100 Gigabyte, are under development today and manufacturers claim availability in the market of 100 Gigabyte hard disks in large quantities by the end of the year 1998.

Typically, a good quality movie of two hours requires a storage capacity of 4 Gigabyte. Thus, a 10 Gigabyte hard disk may typically store two to three full length movies or several typical television shows, each having a length of 30-45 minutes. A 100 Gigabyte hard disk may typically store 20-25 full length movies, or about 100 typical television shows. It is thus appreciated that the high capacity memory 55 may preferably be implemented by a hard disk having a capacity of at least 100 Gigabyte in order to provide good performance of the apparatus 10. However, the capacity of the memory 55 is not meant to be limiting, and the memory 55 may be also implemented by hard disks having capacities lower than 100 Gigabyte.

Alternatively, the high capacity memory 55 may include a plurality of 10 Gigabyte hard disks, such as 10 hard disks, which may together be accessed in order to effectively provide a 100 gigabyte disk space, as is well known in the art.

Preferably, some television programs may be also stored in an external removable memory 65 under control of the processor 45. The external removable memory 65 may include at least one of the following media: a magnetic tape; a CD-ROM (Compact-Disk Read-Only-Memory); a digital video disk (DVD); a write-many read-many compact disk or DVD; and a removable hard disk. The external removable memory 65 is preferably accessible via a removable memory reader and writer 70 which is operatively associated with the data bus 60. It is appreciated that the external removable memory 65 may be used to extend storage capacity of the apparatus 10 so that a plurality of movies may be stored in both the memories 55 and 65. Preferably, the external removable memory 65 may include a recording media changer (not shown) having a plurality of removable memories (not shown) housed in a housing (not shown) and manipulated by a changer robot (not shown).

Preferably, the high capacity memory 55 and the external removable memory 65 may additionally store video and audio information provided by at least one of the following sources: an external video source 75, such as a video camera, a conventional VCR, or an image storage device (not shown); a telephone network 80, which may include a cellular telephone network (not shown); and a local area network (LAN) 85. It is appreciated that the video and audio information provided by the telephone network 80 and the LAN 85 may originate from external sources, such as the World Wide Web (WWW) (not shown), and may be routed to the telephone network 80 and the LAN 85 via networks, such as the Internet (not shown), and a wide area network (WAN) (not shown).

It is appreciated that at least one of the memory 55 and the memory 65 may by divided into two parts: a broadcaster part which may include, for example, commercials which the broadcaster is interested in having a user view; and a user part in which information generated or selected by the user may be stored. It is appreciated that information may be transferred from the user part to the broadcaster part and vice versa.

Preferably, the apparatus 10 communicates with the telephone network 80 via a modem 90 and with the LAN 85 via a LAN interface 95. The video source 75 is typically operatively associated with the processor 45 via the data bus 60. Alternatively, the video source 75 may be associated with an image processor (not shown) which may be operatively associated with the data bus 60.

It is appreciated that the apparatus 10 may also communicate with the headened 15 via one of the telephone network 80 and the LAN 85. Alternatively', the apparatus 10 may communicate with the headend 15 by employing a radio frequency (RF) transmitter 101 for transmitting uplink information via the connector 35, the coaxial cable 30, the antenna 25 and the satellite 20. Preferably, the transmitter 101 may be driven by data provided by the processor 45 via the data bus 60.

Alternatively, the apparatus 10 may communicate with the headend 15 via a Very Small Aperture Terminal (VSAT) as is well known in the art.

The apparatus 10 also preferably includes a compressor/decompressor 106 which is operative to compress/decompress data provided to/retrieved from anyone of the memories 55 and 65. The compressor/decompressor 106 is preferably operatively associated with the data bus 60.

Preferably, the apparatus 10 may be operated by the user via a remote control 111, or an input device, such as a keyboard or a mouse (not shown), which may communicate with the apparatus 10 via an input/output (I/O) interface 115. The I/O interface 115 is preferably comprised in the apparatus 10 and is operatively associated with the processor 45. It is appreciated that instructions and selections inputted by the user via the remote control 111 are executed by the processor 45. Preferably, the remote control 111 includes function keys 127, 121, 122, 123, 124, 125 and 126 for operating special functions as described below.

The apparatus 10 also preferably includes an encryptor/decrypter 131 which is operative to encrypt/decrypt data provided to/retrieved from any one of the memories 55 and 65. The encryptor/decrypter 131 is preferably operatively associated with the data bus 60 and is operative with keys or seeds provided by a smart card 135 via a smart card reader 141. It is appreciated that the keys or seeds provided by the smart card 135 may be operative to provide conditional access to and parental control of data stored in the memories 55 and 65.

The term “parental control” is used throughout the specification and claims to include control by a person who has right to control what programs another person, or persons, may view and/or record/delete, and/or otherwise use. For example, and without limiting the generality of the foregoing, parental control is typically used to control programs whose viewing by children requires consent of a parent.

The processor 45 preferably includes the following units: an agent module 145; a commercial manager 151; a user programming manager 155; an image processor 161; and a viewing analysis module 165.

It is appreciated that at least some of the units comprised in the apparatus 10, and especially the compressor/decompressor 106, may be embodied in a general purpose processor, and the general purpose processor may be operative to execute all functions performed by the units in the apparatus 10 which are comprised in the general purpose processor.

The operation of the apparatus 10 of FIGS. 10A and 10B is now briefly described. Preferably, the apparatus 10 may be employed to digitally record television programs provided by the headend 15 in one of the memories 55 and 65. If the IRD 40 includes a plurality of tuners (not shown), the apparatus 10 may be operative to record several programs simultaneously while viewing any program displayed at any channel, wherein the programs may be transmitted over different channels.

It is appreciated that programs may be transmitted during off-peak hours for display later. Preferably, the programs transmitted during off-peak hours may be associated with at least one of the following codes: a time zone code determining a region; a subscriber identification code identifying a digital television recording apparatus; and a blacklist code identifying subscribers in a blackout area in which the programs must be displayed at later hours.

Additionally, programs which are scheduled for display a number of times a day, such as previews, commercials and clips with a channel logo and theme music, or material that is to be displayed in response to defined conditions, may be transmitted only once or preloaded into memory and retrieved in response to an instruction transmitted from the headend 15. Thus, rather than transmitting the programs which are scheduled for display a number of times a day many times, the programs may be transmitted once, and either instructions to display the programs may be transmitted many times, or an instruction detailing a number of broadcast times may be broadcast once. This allows saving of transmission bandwidth.

Additionally or alternatively, video, audio and control words for a single program need not be transmitted together. For example, if a program is scheduled for transmission with two associated audio channels, a first audio channel including an English version and a second audio channel including a Spanish version, the video portion of the program may be transmitted once and stored in the memory 55. When a particular version is due to be broadcast, such as the English version, the broadcaster may transmit the first audio channel, an instruction to retrieve the video portion from the memory 55, and an instruction to associate the first audio channel with the video portion.

The term “control word” is used throughout the specification and claims to include a control word packet or any appropriate stream of control data/software which is associated with the program or with a portion of the program.

Similarly, the program may be associated with several control words, each corresponding to a different set of on-screen-displays (OSDs), where the OSDs may, for example, include messages in different languages, or with different pricing information depending on when a preview of a Pay-Per-View program is shown. The program may preferably be displayed at different hours with different OSDs.

Additionally, sections of a video portion, an audio portion and/or a control word portion of a program may be broadcast separately. For example, sections of video from the end of the program may be broadcast prior to sections of video from an earlier part of the program, with material from another program in between, and in a different order than that of sections from the audio portion and the control word portion. Additionally, the sections that are broadcast separately may be stored in separate locations in the memory 55 to increase security and to prevent a hacker from decoding a program by detecting a program location in the memory 55.

Further additionally, different sections of the video portion, the audio portion and the control word portion comprised in the program may be transmitted by different transmission sources. This may enhance efficient use of bandwidth and increase security by making it difficult for a hacker to access the program from a single transmission source.

Preferably, the apparatus 10 may be also employed to record programs provided by the video source 75, and programs provided via the LAN 85 and/or the telephone network 80. It is appreciated that the apparatus 10 may operate as a home server for recording/deleting and displaying programs and information generated at various terminals at home and/or provided from networks, such as the Internet.

Additionally, the apparatus 10 may be also employed to transmit programs recorded in one of the memories 55 and 65 to other users, either via a subscriber management system (not shown), or directly to users addresses. Preferably, the programs transmitted to the other users may be transmitted via at least one of the following: the LAN 85; the telephone network 80; and the transmitter 101 or the VSAT. It is appreciated that transmission of programs to the other users and/or reception of programs from any of the other users may require conditional access which may preferably be provided by the smart card 135.

It is appreciated that operations such as recording of programs, retrieval of programs stored in the memories 55 and 65, and deletion of programs stored in the memories 55 and 65 are preferably controlled by the processor 45. The apparatus 10 also preferably enables a variety of additional features such as editing of programs stored in the memories 55 and 65 to include only portions which are of interest to the user.

Another feature available in the apparatus 10 includes freeze of a broadcast television program. In such a case, when the user freezes the program, such as by operating the key 121 on the remote control 111, the program is recorded, for example in the memory 55. When the user unfreezes the program, the apparatus 10 may resume playing the program from the memory 55 rather than from current broadcast of the program. Preferably, the apparatus 10 uses a portion of the memory 55 as a circular buffer and resumes playing the program from the buffer from the point at which the program was frozen. It is appreciated that from that point on, the program is played from the memory 55 in a delayed mode of operation. Thus, the user may stop watching the television program, for example in order to answer to a telephone call, and may resume watching the television program without missing any portion of the program.

It is appreciated that the program may also include marks which are employed to mark portions of the television program that are stored in the circular buffer so that if the user wants to skip some portions of the program to catch-up with the broadcast, the user may input a required mark and jump to the portion marked with the required mark.

It is appreciated that the circular buffer may be controlled by the smart card 135, or any other conventional conditional access module, which provides conditional access to the program stored in the circular buffer. Preferably, the smart card 135 may be operative to disable fast-forward/fast backward operations on the program stored in the circular buffer so that the user is not able to skip portions of the program which are of value to the broadcaster, such as commercials.

It is appreciated that the key 121 may be also operated in a configuration in which the circular buffer is always operative so that a portion of the program, such as the most recently received five minutes of the program, is always stored in the circular buffer. This enables storage of highlights whose viewing may be otherwise missed.

An additional feature available in the apparatus 10 preferably includes display of multiple programs simultaneously on a screen of the television 50. This feature, referred to as picture-in-picture (PIP), may be employed by the user if he does not want to miss programs but has limited time to watch television. Preferably, while watching two programs in a PIP mode, the user may switch between the two programs if he decides to watch only one of the programs on the full television screen. A determination of the program currently watched is preferably provided by the audio currently played.

Alternatively or additionally, in the PIP mode the user may view a premium program on a portion of the television screen without accompanying audio and another program on the rest of the television screen with accompanying audio. In order to see the premium program on the full screen together with the audio, the user may be required to pay for the premium program. Preferably, payment for the program is performed in a conventional method, such as by operating the key 123 on the remote control 111 to accept the program. The payment is preferably handled via the smart card 135.

It is appreciated that at least part of the material received at the apparatus 10 may be compressed and encrypted. In such a case, the material is preferably decompressed at the compressor/decompressor 106 and decrypted at the encryptor/decrypter 131 under control of the smart card 135 as is well known in the art.

Preferably, a program received at the apparatus 10 is associated with a broadcaster set of parameters enabling access to predetermined portions of the program. The broadcaster set of parameters may preferably define the following information which may characterize the program and/or tags which are associated with the program and characterize features of the program:

(1) A type of the program such as a movie, a show, a commercial, and a program provided from the WWW;

(2) supplementary information accompanying the program such as a review of the program as provided by a reviewer, detailed information regarding a product offered by the program, notes accompanying the program, tagged portions of the program, and a percentage of viewers who are currently watching the program;

(3) an associated audio channel in a language which differs from the language used in an original audio channel associated with the program;

(4) program delete enabled/disabled;

(5) parental control associated with at least a portion of the program which requires parental control;

(6) expiration time of the program and/or a number of times the program is watched;

(7) special features, such as PIP availability;

(8) general information, such as a program title, a time when the program is broadcast, a length of the program, a determination whether the program is encrypted and a compression format of the program;

(9) quality and characteristics of material transmitted, such as a data rate, cancellation of material already transmitted such as E-mail, and selective routing of part of the material to selected users;

(10) context specific tagging for use with and/or enhancement of transmitted programs; and

(11) media items, such as WWW content, advertising pointers and pointers to WWW sites.

It is appreciated that the broadcaster set of parameters mentioned above is not meant to be limiting, and it may include additional parameters.

It is further appreciated that not all of the above mentioned parameters must be associated with each program. For example, programs may be transmitted without supplementary information or additional audio channels in various languages.

The parameter of delete enabled/disabled is preferably used mainly in conjunction with commercials as described below or used generally with any type of program. All the other parameters are transmitted as necessary.

It is appreciated that the parameter defining the quality and characteristics of material transmitted may be used, for example, to improve transmission efficiency by transmitting selected information or programs at a higher data rate than other programs which are transmitted at a regular or reduced data rate. It is appreciated that the programs transmitted at a regular or reduced data rate and the programs transmitted at a higher rate may be stored in any of the memories 55 or 65, and upon retrieval from the memories 55 or 65 all the programs may be displayed at conventional frame rates.

The parameter defining context specific tagging for use and/or enhancement of transmitted programs may be used to define specific portions in the programs which may be of special interest to the user, for example, portions in which a favorite actor plays, and portions which may be of special interest to the broadcaster, for example, portions in which a specific product is displayed.

The parameter defining media items, such as WWW content, advertising pointers and pointers to WWW sites may be used to provide the user with direct access to the media items, such as by pointing at a media item.

Preferably, at the apparatus 10, an agent resident in the agent module 145 is operated on the program to determine whether to record the program, for example in the memory 55, and to associate with the program an agent set of parameters enabling access to predetermined portions of the program. The agent preferably learns viewing habits of the user by tracking user's favorite programs and other preferences, such as favorite channels, and main viewing hours. Once user preferences are determined, the agent preferably determines that the program must be recorded if characteristics of the program match the user preferences.

Preferably, if the agent determines that the program must be recorded, the agent may record the program with the agent set of parameters which may be different from the broadcaster set of parameters. It is appreciated that the agent may preferably include an intelligent agent, as described in Israel Patent Application 121230 and corresponding published PCT application WO 99/01984 incorporated above, which learns preferences of the user from observed viewing habits of the user, determines preferences of the user, organizes the user preferences in categories in accordance with a user profile, and adjusts the preferences in accordance with continuously evolving viewing habits of the user. It is further appreciated that the agent may be programmable, and the user may determine preferences by entering information which may be used as inputs for the agent.

Preferably, a plurality of agents may be resident in the agent module 145, each being associated with a member of a family of the user. Preferably, each agent may identify a member of the family to which it corresponds according to a code inputted by the member of the family of the user or a biometrics parameter of the member of the family of the user. Alternatively, each member of the family of the user may select a corresponding agent by using a different key on the remote control 111 or by using a different remote control.

Further alternatively, each member of the family of the user may have an individualized smart card, and each agent may be associated with a corresponding smart card. Preferably, agents may be stored in corresponding smart cards or activated by the corresponding smart cards which may include viewing preferences of the members of the family of the user.

It is appreciated that for simplicity, only one agent is referred to herein below, but the number of agents is not meant to be limiting.

Preferably, the agent set of parameters may override at least a portion of the broadcaster set of parameters. For example, if a program is broadcast with two audio channels accompanying the video, the agent may determine that only one of the audio channels must be recorded with the video. Additionally, the agent may record only a portion of the supplementary information accompanying the program. The agent may also determine additional portions of the program which may require parental control and may override options such as “delete enabled” and expiration time if the program is considered a favorite program.

It is appreciated that the agent may be also operative to determine attributes that are not provided by the broadcaster set of parameters. Thus, the agent set of parameters may preferably additionally define some or all of the following information which may characterize the program and/or tags which are associated with the program and characterize features of the program prior to recording and during recording:

(1) a quality of recording of the program;

(2) a type of program whose recording is required;

(3) titles of favorite programs whose recording is required;

(4) a time and a date when recording of programs is required;

(5) existence of a review attached to the program;

(6) additional context specific tagging and/or media items associated with the program, such as WWW pages pointers, games pointers and advertisement pointers; and

(7) a category of the program, such as sports, music, and comedy.

It is appreciated that the above mentioned agent set of parameters is not meant to be limiting, and it may include additional parameters.

It is further appreciated that the agent may typically determine values of the parameters in the agent set of parameters by learning the preferences of the user from observed viewing habits of the user as mentioned above.

Preferably, the quality of recording of the program is determined by the agent prior to recording of the program, and preferably in accordance with the amount of free storage capacity in the memories 55 and 65. Alternatively, the user may select the quality of recording by pressing the key 126 on the remote control 111. It is appreciated that the parameter defining the quality of recording may also preferably include a routing parameter which routes the program to a selected one of the memories 55 and 65.

The parameters indicating the type of program to be recorded, titles of favorite programs whose recording is required, and the time and the date when recording of programs is required may be either programmed by the user or determined by the agent in accordance with viewing habits of the user studied by the agent.

Preferably, the information stored after the operation of the agent includes the program associated with a current set of parameters which includes a combination of the broadcaster set of parameters that were not changed by the agent set of parameters and the agent set of parameters. The program associated with the current set of parameters forms an addressable program, addressable by the user.

Preferably, the user may retrieve from the memory 55 at least a portion of the addressable program in accordance with settings of the current set of parameters. It is appreciated that the at least a portion of the addressable program is retrieved from the memory 55 under control of the smart card 135 which provides conditional access to at least some of the programs stored in the memory 55. The at least a portion of the addressable program which is retrieved from the memory 55 may preferably be selected by the user via the remote control 111 and displayed to the user on the television 50 or on any other conventional display if access to the selected portion of the addressable program is allowed by the smart card 135.

Preferably, the user may edit the at least a portion of the addressable program by inputting a user set of parameters which enable access to predetermined portions of the program. Thus, the user may browse through the program, delete portions of the program or all the program, mark and combine favorite highlights and add information and tags characterizing the program. It is appreciated that during editing the user set of parameters is associated with the addressable program to generate an edited addressable program. Preferably, once program editing is terminated, the user may preferably store the edited addressable program in the memory 55.

It is appreciated that the user set of parameters may override at least one of a portion of the broadcaster set of parameters, and a portion of the agent set of parameters. For example, while editing, the user may decide not to record part of the supplementary information accompanying the program, or to change the expiration time. Additionally, the user may also input additional criteria for parental control or remove some of the parental control criteria transmitted by the broadcaster. Alternatively or additionally, the user may specify parental control of only at least a portion of a movie which requires parental control so that a child may see the movie without the at least a portion defined by the user.

Preferably, the broadcaster set of parameters may include a subset of parameters which cannot be overridden by any of the agent set of parameters and the user set of parameters. It is appreciated that parameters in the subset of parameters which cannot be overridden may include, for example, the type of the program, conditional access information associated with the program and determining conditional access to the program, a basic parental control rating and a “delete disabled” option in case the program is a commercial or a program whose deletion is not permitted. It is further appreciated that the broadcaster may determine additional parameters in the subset of parameters which cannot be overridden.

The user set of parameters may preferably include, in addition to at least some of the broadcaster set of parameters and the agent set of parameters, parameters defining some or all of the following information which may characterize the program and/or tags which are associated with the program and characterize features of the program:

(1) a program rating provided by the user;

(2) a review of the program—selected from a list of available reviews, or printed by the user;

(3) a request for additional information relating to the program, such as hyper links to local and/or remote local sources, information in various multimedia formats, E-mail, commercials, and information related to advertisement;

(4) a format of the program after editing operations such as mixing portions of the program, reordering of portions of the program, and deletion of portions of the program;

(5) preferred highlights, such as a goal in a football game;

(6) compression preferences for compressing the program prior to storage;

(7) image manipulation; and

(8) video wallpaper selection.

It is appreciated that the above mentioned user set of parameters is not meant to be limiting and it may include additional parameters.

It is further appreciated that the program rating may preferably be programmed by the user by entering a rating parameter from an available list of rating parameters. Alternatively, the user may operate the function key 127 in the remote control 111 to input a rating for the program.

Preferably, a review of the program selected by the user may be associated with the program so that the review entered by the user is recorded as part of the program. Alternatively, the user may retrieve the program with a review selected from a list of available reviews. Typically, after viewing the review the user may decide whether to view the program or not.

The request for additional information relating to the program is preferably transmitted to the headend 15, and the headend 15 may preferably transmit the additional information a short time after the request is received.

Alternatively, the additional information related to the program may be transmitted with the program and stored in the memory 55. When the user enters the request for the additional information, the additional information may be retrieved from the memory 55 and displayed on the television 50.

Further alternatively, the additional information may be scheduled for transmission some time after the user enters the request for the additional information. In such a case, the additional information is preferably transmitted on schedule and not immediately at the request of the user. It is appreciated that the additional information may be also transmitted over a different channel, such as a callback channel or an E-mail channel. This is especially suitable in a case where the additional information includes a pointer to the WWW.

Preferably, the format of the program after editing may be used to replace the original format of the program as saved in the memory 55. Thus, after reformatting, the edited addressable program may occupy less memory capacity than the addressable program. It is appreciated that the user may reformat the addressable program so that only the preferred highlights of the program are stored, and the rest of the program is deleted.

The compression preferences may be employed to apply different compression procedures to the program prior to storage. If, for example, the program transmitted is compressed with the conventional MPEG-2 compression procedure, the user may decide to compress the program with an improved compression procedure, such as the MPEG-4.

Preferably, the parameter defining image manipulation may be generated in response to operations performed by the user on video images of the program. For example, the broadcaster may transmit two programs in a PIP mode. In such a case, when the user selects only one of the programs, the image processor 161 is operative to display the program on the whole screen of the television 50.

It is appreciated that image manipulation may also include rotation and translation of images as well as zoom on the images. Preferably, the image manipulation is performed in the image processor 161 using conventional image processing methods.

The parameter defining a video wallpaper selection may be employed to select a video image, or a series of still video images, to accompany audio when an audio channel is selected. For example, the user may select an image of a sunset from a library of video images to accompany love songs provided via an audio channel.

It is appreciated that user editing operations and inputs may be processed in the user programming manager 155. Preferably, user reactions to the program and the rating of the program is analyzed in the viewing analysis module 165 which preferably executes operations and functions similar to those performed in a conventional Nielsen box.

It is appreciated that at least one of the broadcaster set of parameters, the agent set of parameters, and the user set of parameters may preferably include at least one tag determining a program retrieval parameter, and the program may be retrieved by selecting the tag. Additionally, information resident in the program. such as teletex and video images, may be used to create tags according to which the program may be retrieved and manipulated.

Preferably, the at least one tag determining a program retrieval parameter may be generated and associated with the program when the program is stored in the external removable memory 65. In such a case, the at least one tag may include a label including a reference number which may be used to manage a library of external memory devices and to enable the user to locate a program in an external memory device. Preferably, when the user wants to watch a program stored in an external memory device, the user may be prompted to insert an external memory device having an appropriate label. It is appreciated that similar tags may be applied to programs stored in the memory 55.

Preferably, the key 124 on the remote control 111 may be employed by the user as a conventional “ENTER” key to execute an operation or a series of operations preceding operation of the “ENTER” key 124. When the key 124 is pressed after a series of editing operations on a program, the series of editing operations are entered and the program is stored in an edited form.

The key 125 on the remote control 111 may preferably be employed by the user as a “NEXT” button to browse forward through programs stored in any of the memories 55 and 65. If, for example, the user watches a program retrieved from the memory 55 and presses the key 125, the processor 45 preferably accesses a start point of a program which follows the program in the memory 55. It is appreciated that the “NEXT” button may be used to follow programs in accordance with a selected order or a hierarchy. The selected order and the hierarchy are preferably determined by at least one of the following: the user; the agent; and the broadcaster.

Preferably, the “NEXT” key 125 may include a plurality of “NEXT” buttons (not shown), wherein each of the plurality of “NEXT” buttons may be used in association with a hierarchy. Hierarchies may include, for example, a first hierarchy of stories within the program, a second hierarchy of sections within the program, and a third hierarchy of programs of similar type.

When the user browses through the first hierarchy of stories by pressing one of the plurality of “NEXT” buttons, the user may pass, for example, from a first story in a news program to a second story in the news program.

When the user browses through the second hierarchy of sections by pressing another one of the plurality of “NEXT” buttons, the user may pass, for example, from a news section related to politics in the program to a news section related to sports in the program.

When the user browses through the third hierarchy of programs of similar type by pressing yet another one of the plurality of “NEXT” buttons, the user may pass, for example, from a first comedy program to a second comedy program.

It is appreciated that the “NEXT” key 125 may also include a plurality of “PREVIOUS” buttons (not shown), each associated with one of the plurality of “NEXT” buttons, and each operative to browse backward through the programs stored in any of the memories 55 and 65.

Alternatively or additionally, the “NEXT” button may be used to browse through program categories presented via an EPG.

It is appreciated that at least some of the programs may be encrypted. In such a case, the user must insert the smart card 135 in the smart card reader 141 to allow conditional access to and/or retrieval of the encrypted programs. It is appreciated that conditional access via the smart card 135 to access and/or retrieve encrypted programs is preferably performed in one of methods which are well known in the art. It is further appreciated that programs which are transmitted in clear form do not require presence of the smart card 135, unless the smart card 135 is required for a purpose other than decryption.

Alternatively or additionally, the user may be also required to provide an identification, such as by means of the smart card 135, to allow access to a program that is broadcast in clear form. In such a case, if the user does not provide an appropriate identification, or the user is not entitled to watch the program that is broadcast in clear form, an alert indicating that the user is not entitled to access the program may be generated by the processor 45 and displayed on the television 50.

If the program is a commercial it is preferably processed in the commercial manager 151. Preferably, the commercial receives additional attributes which may be used to control distribution and display of the commercial and to provide feedback to advertisers.

Additionally, the commercial may receive attributes which prevent skipping the commercial without viewing it. Alternatively, the user may be required to view a predetermined amount of commercials over a predetermined time period and the commercial may receive attributes determining whether the user has viewed the commercial and a number of times the user has viewed the commercial.

Preferably, the additional attributes are assigned to the commercial by the broadcaster by associating a commercial set of parameters to the commercial in addition to the above mentioned broadcaster set of parameters.

The commercial set of parameters may preferably define the following additional information and/or tags which specifically characterize the commercial:

(1) a time and a date when the commercial is watched;

(2) expiration after a predetermined number of people have seen the commercial;

(3) fast-forward/fast-backward disabled;

(4) additional information regarding a product offered by the commercial; and

(5) targeting information.

It is appreciated that the above mentioned commercial set of parameters is not meant to be limiting and it may include additional parameters.

Preferably, the broadcaster may receive revenues for displaying the commercial in accordance with a time and a date when the commercial is viewed. For example, the broadcaster may receive increased revenues for the commercial if the user watches the commercial at prime time. Thus, the time and the date when the commercial is watched may be associated with a variable revenue rate, where the revenue rate that the broadcaster receives varies with the time of day and the date when the commercial is viewed by the user.

It is appreciated that information regarding the time and the date when the commercial is viewed is preferably analyzed in the processor 45 and transmitted to the headend 15 via an uplink provided by the transmitter 101 or a VSAT. It is further appreciated that the processor 45 may also delete the commercial after the user has seen it a predetermined number of times.

The parameter defining expiration after a predetermined number of people have seen the commercial may be transmitted to the broadcaster via the callback channel and employed by the broadcaster to know, in near real time, the number of people who watch the commercial and to delete the commercial after a predetermined number of people have seen the commercial. The broadcaster may also employ the parameter defining expiration after a predetermined number of people have seen the commercial to provide a proof of exposure to the commercial against which the advertisers typically pay the broadcaster.

Preferably, the parameter disabling the option of “fast-forward/fast-backward” when the commercial is displayed may be employed to prevent situations in which the user watches a movie and skips the commercial, the commercial being preferably associated with the movie. When this parameter is employed, the processor 45 prevents browsing, and the user may either view the commercial or pass to another program.

Preferably, the parameter disabling the option of “fast-forward/fast-backward” when the commercial is displayed may be employed only until the user has seen the commercial a predetermined number of times in a predetermined time period, such as a week, or a predetermined number of commercials in the predetermined time period. It is appreciated that the predetermined number of times that a user must see a commercial may vary from user to user. Similarly, the predetermined number of commercials that a user must see may vary from user to user.

It is appreciated that the parameter disabling the option of fast-forward/fast backward is not employed in a mode in which the user only browses through available programs.

Alternatively, the operations of fast-forward and fast-backward are enabled and the user may be required to pay more money if he does not watch a predetermined number of commercials per a predetermined time period, such as a month.

Preferably, during fast-forward and fast-backward through the program, even when the program is a commercial, a specially prepared meaningful shortened version of a full commercial may be displayed on the television 50. Preferably, each shortened version of a full commercial may last about 3 seconds, and other shortened versions of other commercials may follow until browsing through fast-forward/fast-backward is ended. It is appreciated that the shortened versions of the full commercials are preferably characterized and treated as full commercials.

Preferably, the user may respond to the commercial by requesting additional information regarding the product offered by the commercial. The request for additional information may preferably be inputted by operating the function key 122 in the remote control 111.

The targeting information is preferably employed to define fields of potential interest of the user or a profile of the user. The commercial is preferably transmitted to the user only if the commercial is in a field of interest of the user or matches the user profile. Alternatively, the commercial is always transmitted, but it is stored only if the commercial is in the field of interest of the user or matches the user profile. It is appreciated that targeting criteria may be stored in the smart card 135.

Additionally or alternatively, the targeting information may include a request for payment so that if the commercial is provided as a premium advertisement service, the user may be required to pay for watching the commercial or to pay either less or more for watching video with or without the commercial. If the commercial is not provided as a premium service, the commercial may be broadcast at off-peak hours.

It is appreciated that the commercial manager 151 may also include a statistics manager (not shown) which may provide statistics information, such as the number of times the commercial was viewed by the user, and the commercial manager 151 may display the commercial or delete it based upon the statistics information. Preferably, the statistics information may be transmitted to the headend 15 via the callback channel. Additionally, at least a portion of the statistics information may be displayed to the user.

Preferably, the commercial manager may be employed to control a commercial catalog including of individually customized advertisements.

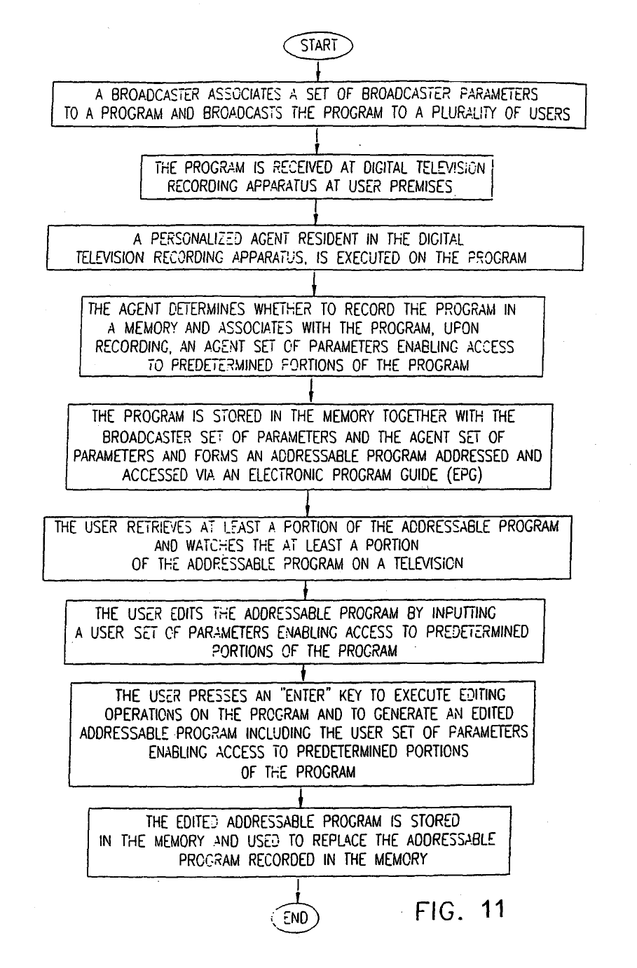

Reference is now made to FIG. 11 which is a simplified flow chart illustration of a preferred method of operation of the apparatus 10 of FIGS. 10A and 10B.

Preferably, a broadcaster associates a set of broadcaster parameters to a program and broadcasts the program to a plurality of users. It is appreciated that the broadcaster may associate different sets of broadcaster parameters to different programs, and each program may receive a unique set of broadcaster parameters. Each broadcaster set of parameters preferably enables access to predetermined portions of each of the different programs.

Preferably, the program is received at digital television recording apparatus at a user premises. At the apparatus, an agent is executed on an EPG which includes links to the program. The agent is preferably personalized according to viewing habits of the user.

Preferably, the agent determines whether to record the program, for example in a memory, and associates with the program, upon recording, an agent set of parameters enabling access to predetermined portions of the program. It is appreciated that the program is preferably stored together with the broadcaster set of parameters and the agent set of parameters thereby generating an addressable program addressed and accessed via the EPG.

Preferably, the agent may be employed, in association with the EPG, to offer the user programs for viewing in accordance with moods of the user or preferences compiled in accordance with history of viewing habits of the user. The programs offered for viewing may include broadcast programs and programs recorded in the memory. Preferably, the programs offered for viewing may also include programs that the user missed viewing of, the programs being arranged in accordance with a viewing priority determined by at least one of the agent and the user.

It is appreciated that the agent may be also employed, in association with the EPG, to manipulate recording and deletion of programs and to enable programmed recording and deletion. The programmed recording and deletion may include recording/deletion of programs that have been watched, recording of programs that are currently displayed, and recording of programs that are scheduled to be broadcast in the future. It is appreciated that the user may view, via the EPG, a list of all recorded programs. Preferably, the user may also search the list of recorded programs in accordance with different criteria, such as program type and title.

Preferably, the user may retrieve at least a portion of the addressable program and watch the at least a portion of the addressable program on a television. Then, the user may perform editing operations on the addressable program which typically result with an input of a user set of parameters enabling access to predetermined portions of the program. The user set of parameters is preferably received at a processor comprised in the apparatus and when the user presses an “ENTER” key on a remote control the addressable program is edited to generate an edited addressable program including the user set of parameters enabling access to predetermined portions. Preferably, the edited addressable program replaces the addressable program recorded in the memory.

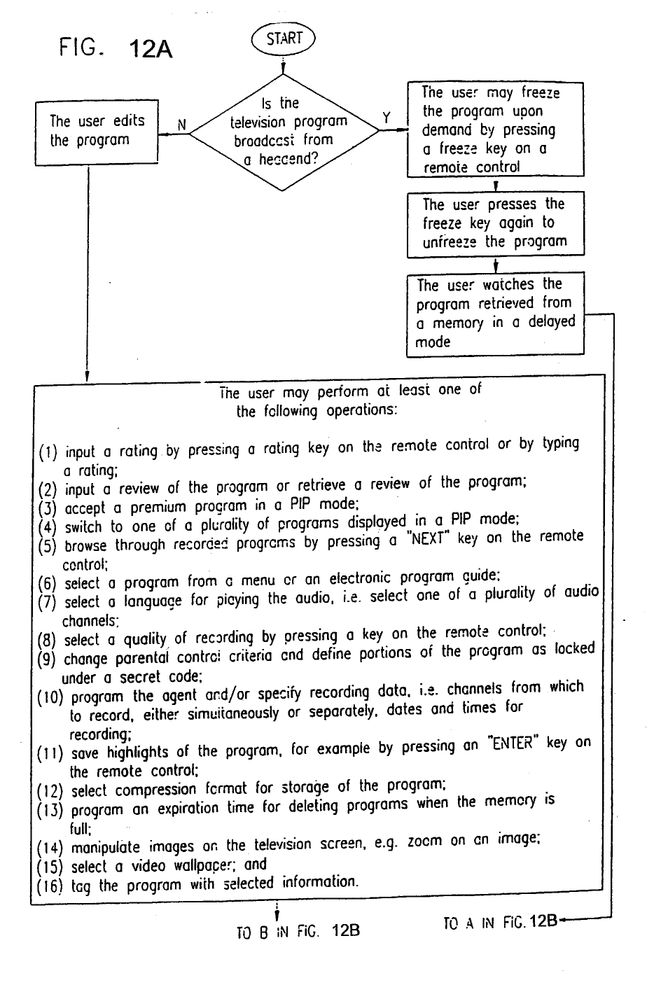

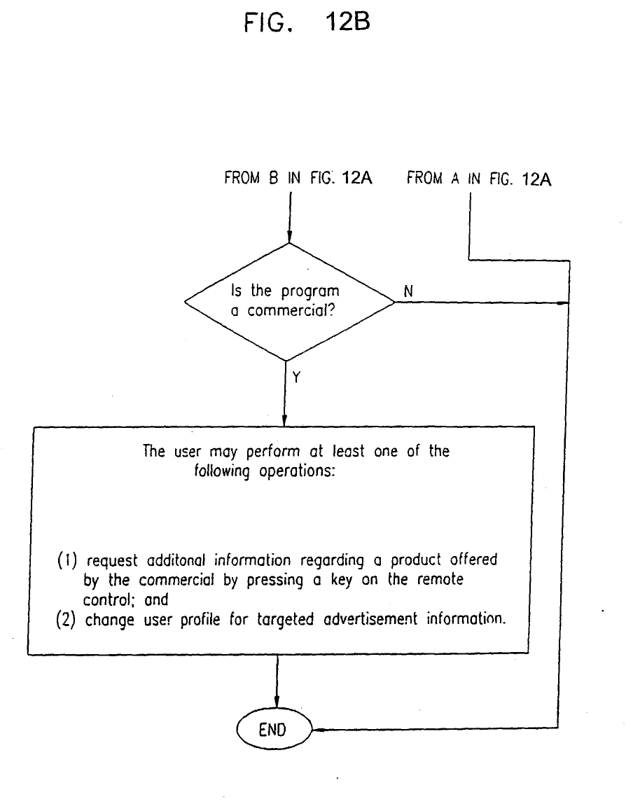

Reference is now made to FIGS. 12A and 12B which together constitute a simplified flow chart illustration of a preferred method of manipulation of television programs recorded in the apparatus 10 of FIGS. 10A and 10B.

Preferably, a user may select viewing a television program broadcast from a headend or a stored television program stored in a memory.

If the user watches a broadcast television program, the user may have, at any time during the broadcast, an option to freeze the program by pressing a freeze key on a remote control. In such a case, the program, starting from the instant the user pressed the freeze key, is recorded in a circular buffer (not shown) which may be comprised in the memory and used to overcome a freeze lag. The circular buffer is preferably loaded and emptied continuously so that when the user presses the freeze key again, the program is retrieved from the buffer which is circularly loaded from the memory and the user may watch the program from the moment the program was frozen.

In a preferred embodiment of the present invention the option to freeze the program may be implemented alone, and not necessarily in combination with other features of the present invention as described herein.

If the user watches the stored television program, the user may edit the program at any time during which the program is played. Preferably, editing of the program may include deletion of parts of the program, combinations of parts of the programs and reordering of the program. Additionally, the user may also combine portions of the program with other programs to create a new program.

Preferably, the user may also perform at least one of the following operations while watching the program by employing the remote control or another appropriate input device:

(1) input a rating by pressing a rating key on the remote control or by typing a rating;

(2) input a review to the program or retrieve a review of the program;

(3) accept a premium program in a PIP mode;

(4) switch to one of a plurality of programs displayed in a PIP mode;

(5) browse through recorded programs or sections of recorded programs by pressing a “NEXT” key on the remote control;

(6) select a program from a menu or an EPG;

(7) select a language for playing the audio, i.e. select one of a plurality of audio channels;

(8) select a quality of recording by pressing a key on the remote control;

(9) change parental control criteria and define portions of the program as locked under a secret code;

(10) program the agent and/or specify recording data, i.e. channels from which to record, either simultaneously or separately, dates and times for recording;

(11) save highlights of the program, for example by pressing an “ENTER” key on the remote control;

(12) select compression format for storage of the program;

(13) program an expiration time for deleting programs when the memory is full;

(14) manipulate images on the television screen, e.g. zoom on an image;

(15) select a video wallpaper; and

(16) tag the program with selected information.

Additionally, if the program is a commercial the user may also perform at least one of the following operations while watching the commercial by employing the remote control or another appropriate input device:

(1) request additional information regarding a product or a program offered by the commercial by pressing a key on the remote control; and

(2) change user profile for targeted advertisement information.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described herein above. Rather the scope of the invention is defined only by the claims which follow:

What is claimed is:

1. A television system comprising:
a television network; and
transmitting apparatus for transmitting program schedule information to a multiplicity of subscriber units, at least one of said multiplicity of subscriber units including:
a receiving unit for receiving said program schedule information from said television network;
a profile storage unit for storing at least one viewer preference profile of at least one television viewer;
an intelligent agent for customizing said program schedule information based, at least in part, on said viewer preference profile, to produce a program guide comprising customized program schedule information; and
display apparatus for displaying the program guide.

2. A subscriber unit for use in a television system comprising a television network and transmitting apparatus for transmitting program schedule information. the subscriber unit comprising:
a receiving unit for receiving said program schedule information;
a profile storage unit for storing at least one viewer preference profile of at least one television viewer;
an intelligent agent for customizing said program schedule information based, at least in part, on said viewer preference profile, to produce a program guide comprising customized program schedule information; and
display apparatus for displaying the program guide.

3. A television system comprising:
a television network; and
transmitting apparatus for transmitting program schedule information to a multiplicity of subscriber units, the transmitting apparatus comprising a head end, the headend including:
a profile storage unit for storing at least one viewer preference profile of at least one television viewer associated with one of said multiplicity of subscriber units; and
an intelligent agent for customizing said program schedule information based, at least in part, on said viewer preference profile, to produce customized program schedule information,
wherein said transmitting apparatus is operative to transmit the customized program schedule information to said one of said multiplicity of subscriber units, and
at least one of said multiplicity of subscriber units includes:
a receiving unit for receiving said customized program schedule information from said television network; and
display apparatus for displaying a program guide comprising the customized program schedule information.

4. A head end for use in a television system comprising a television network and transmitting apparatus for transmitting customized program schedule information to at least one subscriber unit, the headend comprising:
a profile storage unit for storing at least one viewer preference profile of at least one television viewer associated with said at least one subscriber unit; and
an intelligent agent for customizing said program schedule information based, at least in part, on said viewer preference profile, to produce customized program schedule information.

5. Apparatus according to any of the above claims and wherein said transmitting apparatus comprises network transmitting apparatus for transmitting over said television network.

6. Apparatus according to any of the above claims and wherein said transmitting apparatus comprises:
recording apparatus for recording information on a removable medium; and
means for sending said removable medium to a subscriber location comprising said subscriber unit,
and said subscriber unit includes loading apparatus for loading said information from said removable medium into said subscriber unit.

7. Apparatus according to any of the above claims and wherein said intelligent agent also comprises profile determination apparatus for determining viewer preference profile information for at least one television viewer and for providing said viewer preference profile information to said profile storage unit for storage as a viewer preference profile,
wherein said profile determination apparatus determines said viewer preference profile information by monitoring television viewing behavior of said at least one television viewer.

8. Apparatus according to claim 7 and wherein said television viewing behavior comprises viewing at least a portion of at least one viewed television program.

9. Apparatus according to claim 8 and wherein said television viewing behavior comprises said television viewer viewing only a portion of at least one viewed television program.

10. Apparatus according to claim 9 and wherein said profile determination apparatus compares a length of said portion of said at least one viewed television program to a predetermined viewing threshold length to determine whether said length is greater than said threshold length, and
wherein said profile determination apparatus determines said viewer preference profile information based, at least in part, on whether said length is greater than said threshold length.

11. Apparatus according to claim 10 and wherein, when said length is determined to be less than said threshold length, said profile determination apparatus determines said viewer preference profile information without regard to said viewing only a portion of said at least one television program.

12. Apparatus according to claim 10 and wherein, when said portion is determined to be less than said threshold, said profile determination apparatus determines that said viewer is engaged in channel surfing behavior, and
said profile determination apparatus determines said viewer preference profile information based, at least in part, on said channel surfing behavior.

13. Apparatus according to any of claims 7-12 and wherein said program schedule information comprises a first plurality of criteria, at least one of said first plurality of criteria being associated with each of a second plurality of television programs, and
said profile determination apparatus determines said viewer preference profile information based, at least in part, on at least one of said plurality of criteria associated with said at least one viewed television program.

14. Apparatus according to any of claims 7-13 and wherein said profile determination apparatus determines said viewer preference profile information, at least in part, in accordance with input provided by said at least one television viewer.

15. Apparatus according to any of claims 7-14 and wherein said profile determination apparatus determines viewer preference profile information from a reaction of said at least one television viewer to previously displayed customized program schedule information.

16. Apparatus according to any of the above claims and wherein each said viewer preference profile comprises a viewer preference profile of exactly one viewer.

17. Apparatus according to any of claims 1-15 and wherein at least one said viewer preference profile comprises a viewer preference profile of a plurality of viewers.

18. Apparatus according to any of the above claims and also comprising viewer preference profile loading apparatus for providing a recorded viewer preference profile to the profile storage unit for storage.

19. Apparatus according to claim 18 wherein said viewer preference profile loading apparatus receives said recorded viewer preference profile via said television network.

20. Apparatus according to either claim 18 or claim 19 and wherein said viewer preference profile loading apparatus receives said viewer preference profile from profile storage apparatus located remotely thereto.

21. Apparatus according to any of the preceding claims and wherein said customizing comprises emphasizing at least a portion of said customized program schedule information based, at least in part, on said viewer preference profile.

22. Apparatus according to any of the preceding claims and wherein said customizing comprises deemphasizing at least a portion of said customized program schedule information based, at least in part, on said viewer preference profile.

23. Apparatus according to any of the preceding claims and wherein said customizing comprises tailoring a custom channel based, at least in part, on said viewer preference profile.

24. Apparatus according to any of the preceding claims and wherein said customizing comprises automatically tuning to a program selected based, at least in past, on said viewer preference profile.

25. Apparatus according to any of the preceding claims and wherein said customizing comprises automatically recording, on recording apparatus, a program selected based, at least in part, on said viewer preference profile.

26. Apparatus according to any of the preceding claims and wherein said customizing comprises ordering at least some of said customized program schedule information based, at least in part, on said viewer preference profile.

27. Apparatus according to any of the preceding claims and wherein said display apparatus is operative to display an on-screen alert comprising at least part of said customized program schedule information.

28. Apparatus according to claim 27 and wherein said alert comprises an unsolicited alert.

29. Apparatus according to claim 28 and wherein said unsolicited alert comprises audience viewing information comprising an indication of a proportion of an audience currently viewing a program.

30. Apparatus according to claim 29 and wherein said program comprises a program currently being viewed by a viewer.

31. Apparatus according to claim 29 and wherein said program comprises a program not currently being viewed by a viewer.

32. Apparatus according to either claim 27 or claim 28 and wherein said display apparatus displays said on-screen alert a predetermined period of time before a scheduled starting time of a television program, said at least part of said customized program schedule information comprising information associated with said television program.

33. Apparatus according to any of the above claims and wherein said customizing comprises displaying an indication of a proportion of an audience currently viewing a program.

34. Apparatus according to claim 33 and wherein said proportion of an audience comprises a proportion of an audience viewing a program currently being viewed by a viewer.

35. Apparatus according to claim 33 and wherein said proportion of an audience comprises a proportion of an audience viewing a program not currently being viewed by a viewer.

36. Apparatus according to any of the preceding claims and wherein said display apparatus comprises an icon-based guide generator for producing an icon-based hierarchical program guide comprising said program schedule information, and
the program guide comprises the icon-based hierarchical program guide.

37. A television system comprising:
a television network; and
transmitting apparatus for transmitting program schedule information to a multiplicity of subscriber units, each subscriber unit including:
a receiving unit for receiving said program schedule information from said television network;
an icon-based guide generator for producing a program guide comprising an icon-based hierarchical program guide comprising said program schedule information; and
display apparatus for displaying said program guide.

38. A subscriber unit for use in a television system comprising a television network and transmitting apparatus for transmitting program schedule information, the subscriber unit comprising:
a receiving unit for receiving said program schedule information from said television network;
an icon-based guide generator for producing a program guide comprising an icon-based hierarchical program guide comprising said program schedule information; and
display apparatus for displaying said program guide.

39. A method for providing a program guide in a television system, the method comprising:
providing a television network; and
transmitting program schedule information to a multiplicity of subscriber units, each subscriber unit performing the following steps:
receiving said program schedule information from said television network;
storing at least one viewer preference profile of at least one television viewer;
employing an intelligent agent to customize said program schedule information based, at least in part, on said viewer preference profile, to produce a program guide comprising customized program schedule information; and
displaying the program guide.

40. A method for providing a program guide in a television system comprising a television network and transmitting apparatus for transmitting program schedule information, the method comprising:
receiving said program schedule information;
storing at least one viewer preference profile of at least one television viewer;
employing an intelligent agent to customize said program schedule information based, at least in part, on said viewer preference profile, to produce a program guide comprising customized program schedule information; and
displaying the program guide.

41. A method for providing a program guide in a television system, the method comprising:
providing a television network; and
transmitting program schedule information to a multiplicity of subscriber units,
wherein the step of transmitting comprises:
storing at least one viewer preference profile of at least one television viewer associated with one of said multiplicity of subscriber units;
employing an intelligent agent to customize said program schedule information based, at least in part, on said viewer preference profile, to produce customized program schedule information;
transmitting the customized program schedule information to said one of said multiplicity of subscriber units;
receiving, at said one of said multiplicity of subscriber units, said customized program schedule information from said television network; and
displaying a program guide comprising the customized program schedule information.

42. A method for providing a program guide in a television system comprising a television network and transmitting apparatus for transmitting customized program schedule information, the method comprising:
storing at least one viewer preference profile of at least one television viewer associated with one of said multiplicity of subscriber units; and
customizing said program schedule information based, at least in part, on said viewer preference profile, to produce customized program schedule information.

43. A method for providing a program guide in a television system, the method comprising:
providing a television network; and
transmitting program schedule information to a multiplicity of subscriber units, each subscriber unit performing the following steps:
receiving said program schedule information;
producing a program guide comprising an icon-based hierarchical program guide comprising said program schedule information; and
displaying said program guide.

44. A method for providing a program guide in a television system comprising a television network and transmitting apparatus for transmitting program schedule information, the method comprising:
receiving said program schedule information;
producing a program guide comprising an icon-based hierarchical program guide comprising said program schedule information; and
displaying said program guide.

45. A headend for use in a television system comprising a television network and transmitting apparatus for transmitting customized program schedule information to a multiplicity of subscriber units, the transmitting apparatus comprising the headend, the headend comprising:
a profile creation unit for creating at least one viewer preference profile of at least one television viewer associated with one of said multiplicity of subscriber units, based on viewer information associated with said one of said multiplicity of subscriber units; and
a transmission unit for transmitting said at least one viewer preference profile to said one of said multiplicity of subscriber units.

46. A method for providing a program guide in a television system comprising a television network and transmitting apparatus for transmitting customized program schedule information to a multiplicity of subscriber units, the method comprising:
creating at least one viewer preference profile of at least one television viewer associated with one of said multiplicity of subscriber units, based on viewer information associated with said one of said multiplicity of subscriber units; and
transmitting said at least one viewer preference profile to said one of said multiplicity of subscriber units.

47. A method for providing a viewer preference profile in a television system comprising a plurality of subscriber units, the method comprising:
recording, at a first subscriber unit, a viewer preference profile on a removable medium;
loading, at a second subscriber unit, said viewer preference profile from said recording medium; and
customizing a program guide, at said second subscriber unit, based, at least in part, on said viewer preference profile.

48. A method for providing audience information to a viewer of a television system, the method comprising:
collecting viewing data from a multiplicity of viewers of a television system;
computing audience information from the collected viewing data; and
transmitting the computed audience information to a viewer of the television system.

49. A method according to claim 48 and also comprising:
displaying the computed audience information to the viewer of the television system.

50. A method according to either claim 48 or claim 49 and wherein the computed audience information comprises real-time computed audience information.

51. A method for providing a program guide in a television system comprising a television network and transmitting apparatus for transmitting information to a multiplicity of subscriber units, the method comprising:
creating at least one viewer preference profile of at least one television viewer associated with one of said multiplicity of subscriber units, based on viewer information associated with said one of said multiplicity of subscriber units;
creating a customized program guide based, at least in part, on said at least one viewer preference profile; and
transmitting said customized program guide to said one of said multiplicity of subscriber units.

52. A method according to claim 51 and wherein said transmitting step comprises transmitting via at least one of the following:
conventional mail;
electronic mail;
provision of a World Wide Web site comprising said customized program guide; and
wireless transmission to a portable electronic receiving device.

53. Apparatus according to any of claims 36-38 and wherein said icon-based hierarchical program guide comprises a plurality of icons, and
at least one of said plurality of icons is associated with additional information, said additional information being provided to a user upon request.

54. Apparatus according to claim 53 and wherein said additional information comprises at least one of the following: audio material; visual material; audio-visual material; multimedia material; a computer program; and at least one preview of at least one program.

55. Apparatus according to either claim 53 or claim 54 and wherein said additional information comprises a plurality of customized items of information, and
at least one of said plurality of customized items of information is provided to said user based, at least in part, on at least one of the following: a user preference; a conditional access parameter; and a region in which said user is located.

56. A digital television recording method comprising:
broadcasting a television program associated with a broadcaster set of parameters enabling access to a first set of predetermined portions of the program;
operating an agent for determining whether to record the program and for associating with the program, upon recording of the program, an agent set of parameters enabling access to a second set of predetermined portions of the program;
storing the program together with the broadcaster set of parameters and the agent set of parameters to generate an addressable program;
retrieving at least a portion of the addressable program;
displaying said at least a portion of the addressable program to a user;
receiving from the user a user set of parameters enabling access to a third set of predetermined portions of the addressable program;
editing the addressable program to include said user set of parameters enabling access to the third set of predetermined portions of the addressable program thereby generating an edited addressable program; and
storing the edited addressable program.

57. A method according to claim 56 and wherein said agent set of parameters is operative to override at least a portion of the broadcaster set of parameters.

58. A method according to claim 56 or clam 57 and wherein said user set of parameters is operative to override at least one of the following: a portion of the broadcaster set of parameters; and a portion of the agent set of parameters.

59. A method according to any of claims 56-58 and wherein said broadcaster set of parameters comprises a subset of parameters which cannot be overridden by any of the following: the agent set of parameters; and the user set of parameters.

60. A method according to any of claims 56-59 and wherein at least one of said broadcaster set of parameters, said agent set of parameters, and said user set of parameters comprises a tag determining at least one of the following: a program retrieval parameter; and a content retrieval parameter.

61. A method according to any of claims 56-60 and wherein said agent set of parameters comprises a recording quality parameter determining a quality of recording of the program.

62. A method according to any of claims 56-60 and wherein said user set of parameters comprises a rating parameter determining a rating of the program as provided by the user.

63. A method according to any of claims 56-62 and wherein the television program comprises a commercial and the broadcaster set of parameters comprises a commercial set of parameters.

64. A method according to any of claims 56-63 and wherein the television program comprises a commercial and the broadcaster set of parameters comprises a parameter determining a request for additional information related to at least one of the following: the commercial; and the program.

65. A method according to any of claims 56-64 and wherein the television program comprises a commercial and the broadcaster set of parameters comprises a parameter determining expiration of the commercial after an event comprising at least one of the following: a predetermined number of people having seen the commercial; and the user having seen the commercial a predetermined number of times.

66. A method according to any of claims 56-65 and wherein the broadcaster set of parameters comprises a parameter disabling fast-forward/fast backward browsing through the program.

67. A method according to any of claims 56-62 and wherein the television program comprises two separate television programs displayed simultaneously in a picture-in-picture (PIP) mode on a television screen, and the user set of parameters comprises a parameter determining a viewing selection for viewing only one of the two separate television programs on the full television screen.

68. A method according to any of claims 56-67 and wherein the broadcaster set of parameters comprises at least one parameter determining at least one of the following information fields: a type of the program; supplementary information accompanying the program; an associated audio channel in a language which differs from a language used in an original audio channel associated with the program; program delete enabled/disabled; parental control associated with at least a portion of the program which requires parental control; an expiration time of the program; picture-in-picture availability; a program title; a time when the program is broadcast; a length of the program; a determination whether the program is encrypted; a compression format of the program; characteristics of the program; cancellation of material already transmitted in the program; selective routing of part of the material to selected users; context specific tagging; and a media item.

69. A method according to any of claims 56-60 and 62-68 and wherein the agent set of parameters comprises at least one parameter determining at least one of the following information fields: a quality of recording of the program; a type of program whose recording is required; at least a title of a favorite program whose recording is required; a time and a date when recording of the program is required; and existence of a review attached to the program; context specific tagging; a media item; and a category of the program.

70. A method according to any of claims 56-61 and 63-69 and wherein the user set of parameters comprises at least one parameter determining at least one of the following information fields: a program rating provided by the user; a review of the program; a request for additional information relating to the program; a format of the program after editing operations; at least one highlight in the program; compression preferences for compressing the program prior to storage; image manipulation; and video wallpaper selection.

71. A method according to any of claims 56-70 and wherein said first set of predetermined portions of the program, said second set of predetermined portions of the program, and said third set of predetermined portions of the addressable program include identical portions of the program.

72. A digital recording method comprising:
determining whether to record a program; and
recording the program in response to a recording determination at a recording quality determined by a recording quality parameter.

73. A digital recording method comprising:
determining whether to record a program;
storing the program in response to a recording determination; and
retrieving the program in accordance with a rating given to the program.

74. A digital recording method comprising:
determining whether to record a program;
storing the program in response to a recording determination; and
retrieving the program in accordance with a browsing hierarchy.

75. A digital recording method comprising:
determining whether to record a program;
recording the program in a circular buffer upon first activation of a freeze selector from a moment of the first activation of the freeze selector;
conditionally accessing the program recorded in the circular buffer for retrieval of the program from the circular buffer upon second activation of the freeze selector; and
playing the program retrieved from the circular buffer from the moment of the first activation of the freeze selector.

76. Apparatus for digital recording of a program comprising:
a receiver for receiving the program associated with a broadcaster set of parameters enabling access to a first set of predetermined portions of the program;
an agent module operatively associated with the receiver and operative to determine whether to record the program and to associate with the program, upon recording of the program, an agent set of parameters enabling access to a second set of predetermined portions of the program;
a memory operatively associated with the agent module and operative to store an addressable program, the addressable program including the program associated with the broadcaster set of parameters and the agent set of parameters;
a display operatively associated with the agent module, the receiver and the memory and operative to display at least a portion of the addressable program to a user;
an input/output (I/O) interface operatively associated with the agent module and operative to receive from the user a user set of parameters enabling access to a third set of predetermined portions of the addressable program; and
a user programming manager operatively associated with the memory, the I/O interface, the agent module, the receiver and the display and operative to generate an edited addressable program by editing the addressable program to include the user set of parameters enabling access to the third set of predetermined portions of the program, and to store the edited addressable program in the memory.

77. Apparatus for digital recording of a television program comprising:
a processor for determining whether to record the television program;
a memory associated with the processor and operative to store the television program in response to a recording determination received from the processor; and
a recording quality selector associated with the processor and the memory and operative to select a recording quality parameter determining a quality of storage of the television program in the memory.

78. Apparatus according to claim 77 and also comprising a freeze selector operatively associated with the processor, wherein upon a first activation of the freeze selector, the processor is operative to record the program in the memory from a moment of first activation of the freeze selector, and upon a second activation of the freeze selector, the processor is operative to play the program recorded in the memory from the moment of first activation.

79. Apparatus according to claim 77 or claim 78 and also comprising:
a rating activator associated with the processor and the memory and operative to input information determining a rating given to the program.

80. Apparatus according to any of claims 77-79 and also comprising:
a NEXT key selector associated with the processor and the memory and operative to browse through television programs stored in the memory.

81. Apparatus according to claim 76 and wherein said NEXT selector is operative to browse through television programs stored in the memory in accordance with an order determined by at least one of the following: the user; the agent; and the broadcaster.

82. Apparatus according to claim 80 and wherein said NEXT selector is operative to browse through television programs stored in the memory in accordance with a hierarchy.

83. Apparatus according to claim 82 and wherein said hierarchy is determined by at least one of the following: the user; the agent; and the broadcaster.

84. Apparatus for digital recording of a television program comprising:
a processor for determining whether to record the television program;
a memory associated with the processor and operative to store the television program in response to a recording determination received from the processor; and
a rating activator associated with the processor and the memory and operative to input information determining a rating given to the television program.

85. Apparatus according to claim 84 and also comprising a freeze selector operatively associated with the processor, wherein upon a first activation of the freeze selector, the processor is operative to record the program in a circular buffer from a moment of first activation of the freeze selector, and upon a second activation of the freeze selector, the processor is operative to play the program recorded in the circular buffer from the moment of first activation.

86. Apparatus according to claims 84 or 85 and also comprising:
a NEXT key selector associated with the processor and the memory and operative to browse through television programs stored in the memory.

87. Apparatus for digital recording of a television program comprising:
a processor for determining whether to record the television program;
a memory associated with the processor and operative to store the television program in response to a recording determination received from the processor; and
a NEXT key selector associated with the processor and the memory and operative to browse through television programs stored in the memory.

88. Apparatus for digital recording of a program comprising:
a processor for determining whether to record the program;
a circular buffer associated with the processor and operative to store the program in response to a recording determination received from the processor;
a conditional access module for providing conditional access to the program stored in the circular buffer; and
a freeze selector operatively associated with the processor, wherein upon a first activation of the freeze selector, the processor is operative to record the program in the circular buffer from a moment of first activation of the freeze selector, and upon a second activation of the freeze selector, the processor is operative to play the program recorded in the circular buffer from the moment of first activation in accordance with conditions determined by the conditional access module.

89. Apparatus according to claim 88 and wherein said conditions determined by the conditional access module comprise disabling of fast-forward/fast-backward over selected portions of the program.
